(19) United States
(12) Patent Application Publication
(10) Pub. No.: US 2006/0039558 A1
(43) Pub. Date: Feb. 23, 2006

(54) Pseudo-random number generation method and pseudo-random number generator

(76) Inventors: Masakatu Morii, Tokushima (JP); Yoshiaki Shiraishi, Osaka (JP)

Correspondence Address: SUGHRUE MION, PLLC, 2100 PENNSYLVANIA AVENUE, N.W., SUITE 800, WASHINGTON, DC, 20037, US

(21) Appl. No.: 10/530,574

(22) PCT Filed: Jul. 10, 2003
(86) PCT No.: PCT/JP03/08794

§ 371 Date: Apr. 7, 2005

(30) Foreign Application Priority Data
Oct. 7, 2002 (JP) 2002-294184

(51) Int. Cl. H04L 9/00

(52) U.S. Cl. 380/46

(57) ABSTRACT

A bit string obtained by sampling, every the number s, bits of a bit string whose output sequence is M sequence, when the bit number per one cycle of the M sequence is prime to the derived value, constitutes M sequence of a linear feedback shift register having other construction. Further, the linear feedback shift register can be determined from bits corresponding to at least two cycles by Berlekamp-Massay algorithm, whereby the linear feedback shift register 11 can be easily and dynamically reconstructed based on the initial state value.

### BACKGROUND OF INVENTION

1. Field of the Invention

The present invention relates to a method for generating pseudo-random numbers useful in cryptography communication and digital signature, a pseudo-random number generator and a program for generating pseudo-random numbers.

2. Description of the Related Art

Conventionally, in case information communication is carried out through wire or radio, the information is transmitted after its encryption so as not to leak its content to third party. Systems of the encryption include a stream cipher system. In the stream cipher system, transmission and reception sides generate the same pseudo-random numbers as each other, and the transmission side prepares a bit string of a cryptogram by using a bit string of the pseudo-random numbers and a bit string of a plaintext to transmit the bit string as cryptogram to the reception side, while the reception side receives the cryptogram of bit string and decrypts the bit string to the plaintext by finding a bit string of the plaintext using both the bit string of cryptogram and the bit string of pseudo-random numbers.

FIG. 16 is a figure explaining a conventional stream cipher system. An encryption device 100 on the transmission side is provided with a pseudo-random number generator 101 and a logic operation processing part 102, and a decryption device 110 on the reception side is provided with a pseudo-random number generator 111 and a logic operation processing part 112.

The pseudo-random number generator 101 of the encryption device 100 and the pseudo-random number generator 111 of the decryption device 110 have the logical structure that one given key generates the same pseudo-random numbers as each other. The logic operation processing part 102 of the encryption device 100 and the logic operation processing part 112 of the decryption device 110 carry out an operation processing of exclusive-or in unit of bit.

FIG. 17 is a figure explaining the pseudo-random number generator 101 of the encryption device 100. However, the pseudo-random number generator 111 of the decryption device 110 has the same structure as the pseudo-random number generator 101 of the encryption device 100, and therefore its detailed explanation is omitted.

The pseudo-random number generator 101 is a nonlinear-combiner-type pseudo-random number generator (nonlinear combiner generator), and provided with plural linear feedback shift registers (LFSR) 103 disposed in a row with one another and a nonlinear conversion part 104, which nonlinearly converts a bit string outputted from each of the linear feedback shift registers 103 to generate pseudo-random numbers, as shown in FIG. 17. In this conventional example, each of the linear feedback shift registers 103 outputs one bit (X₁, X₂, - - - X_{L}) by one shifting operation, while the nonlinear conversion part 104 outputs pseudo-random numbers of one bit based on a bit string input from each of the linear feedback shift registers 103.

FIG. 18 is a figure simply explaining a conventional structure of the linear feedback shift register 103. The linear feedback shift register 103 is provided with plural shift registers 105 capable of storing one bit information and plural exclusive-or operation circuits 106, and a feedback tap 107 is connected between output of each of the shift registers 105 and input of one of the exclusive-or operation circuits 106. In the feedback taps 107 (cₙ₋₁, cₙ₋₂, - - - cₙ), each of the feedback taps 107 shows connection if it is “1”, while it shows disconnection if it is “0”, and each is beforehand determined to “1” or “0”.

If the number of the shift registers 105 is “n” (n plurality), it is known that one of the shift registers 105 has a maximum cycle of output sequence of (2ˆn)-1. The output sequence is referred to as M sequence. The term “2ˆn” means 2ⁿ (raising 2 to n power). The mark “ˆ” is hereinafter described before the exponent part.

For example, in the case of the linear feedback register 103 shown in FIG. 14, a characteristic polynomial generating M sequence is represented as follows:
C(x)=(Xˆn)+cₙ₋₁(Xˆ(n-1)+ - - - +c₁X+1

The exponent n in the first member of the characteristic polynomial represents the order of the linear feedback shift register 103, i.e., the number of the shift register. The exponents in the second or more members represent the connection positions of the feedback taps 107. If the characteristic polynomial is set to be a primitive polynomial, the linear feedback shift register 103 outputs M sequence.

Such the nonlinear-combiner-type pseudo-random number generator (nonlinear combiner generator) can be structured by a simple logic based on logic operation in unit of bit. Hence, the generator is considered to be suitable for mounting in a hardware.

It has been already proposed that output from the linear feedback shift register is changed based on a operation processing such as exclusive-or, which is described in, for example, JA06-342257.

### SUMMARY OF THE INVENTION

First Problem to be Solved

However, the construction of the linear feedback shift registers 103, i.e., the number of shift registers and the positions of connections, and an initial state value can be specified by observing outputs of the linear feedback shift register two times more than the number of the shift. Thus, in case the linear feedback shift register 103 whose construction is fixed is used as the pseudo-random number generator 101 as it is, there are problems such as weak encryption strength (strength of cipher) and poor security.

Further, when, in the linear feedback shift registers 103, the position and number of the connection of the registers are changed depending upon the change of the characteristic polynomial, the output of the linear feedback shift register is apt to be changed from M sequence (M-series) to short-period shorter than the M sequence, to bring about reduction of the strength. Hence, the characteristic polynomial should be fixed to the value outputting M sequence, and therefore it is considered that the construction of the linear feedback shift register cannot be easily changed.

Second Problem to be Solved

In the conventional nonlinear-combiner-type pseudo-random number generator, it is required that the linear feedback shift registers 103 carry out the operation in unity of one bit repeatedly and continuously. Such a processing is suitable for performance of a hardware, which can perform the processing at relative high speed. However, the processing is a weak point for software, in which the processing is done at extremely low speed compared with in case of the hardware.

In the nonlinear conversion part 104, simple operations such as logical multiplication and exclusive-or are carried out. Hence, the throughput of the linear feedback shift registers 103 is smaller than that of the nonlinear conversion part 104, and therefore a part outputting a random number bit string in the whole generator, i.e., the linear feedback shift registers 103, constitutes a hindrance. Thus, when conventional nonlinear-combiner-type pseudo-random number generator is equipped in the software, the whole throughput is reduced compared with that the generator is equipped in the hardware. It is difficult that the generator is used in the software.

Further, in order to obtain sufficient encryption strength of the pseudo-random numbers, the number of the linear feedback shift register 103 and the number of the shift register 105 of the linear feedback shift register 103 are required to be more than a certain level. However, the throughput is reduced with increase of the number of the linear feedback shift registers 103 or the number of the shift registers 105 of the linear feedback shift register 103. Hence, it has been difficult to acquire high throughput with keeping high encryption strength.

The present invention has been made to resolve at least one of the above-mentioned the first and second problems to be solved. The object of the present invention is to provide a method and program for generating pseudo-random numbers and a pseudo-random number generator in which the construction of the linear feedback shift register can be easily and dynamically changed with maintaining high encryption strength, and higher throughput can be acquired with keeping sufficiently high encryption strength.

The method for generating pseudo-random numbers described in claim 1 comprises:

a first step for setting up an initial state value of a linear feedback shift register including n shift resistors and capable of outputting a bit string having bit number of (2ˆn)-1 per one cycle;

a second step for finding a derived value prime to the bit number per one cycle of the linear feedback shift register based on the initial state value by means of a predetermined operation processing;

a third step for multiplying the derived value by a value obtained by multiplying the bit numbers per one cycle by two or more to calculate a bit number (of bit string) to be outputted from the first linear feedback shift register;

a fourth step for outputting a bit string corresponding to the calculated bit number based on the initial state value from the linear feedback shift register;

a fifth step for taking out a bit from the output bit string every the derived value to generate a new bit string;

a sixth step for changing construction of the linear feedback shift register such that the new bit string can be outputted from the resistor; and

a seventh step for generating pseudo-random numbers based on the initial state value from the linear feedback shift register changed in its construction.

In the invention, a bit string obtained by sampling, every the number s, bits of a bit string whose output sequence is M sequence, constitutes M sequence of a linear feedback shift register having other construction, when the bit number (=(2ˆn)-1) per one cycle of the M sequence is prime to the derived value (s). Further the invention utilizes that the linear feedback shift register can be obtained from the bit string having a bit number of at least two cycles.

According to the invention, the initial state value of a linear feedback shift register having n shift resistors and capable of outputting a bit string having bit number of (2ˆn)-1 per one cycle is set up, and a derived value prime to the bit number per one cycle of the linear feedback shift register based on the initial state value is determined by means of the predetermined operation processing.

Subsequently, the derived value is multiplied by a value obtained by multiplying the bit number per one cycle by two or more to calculate a bit number to be outputted from the first linear feedback shift register, a bit string corresponding to the calculated bit number is output based on the initial state value from the linear feedback shift register, and a bit is taken out from the output bit string every the number of the derived value to generate a new bit string.

Then, the linear feedback shift register is reconstructed such that the new bit string can be outputted from the resistor, and pseudo-random numbers are generated based on the initial state value from the reconstructed linear feedback shift register.

According to this method, the construction of the linear feedback shift register can be dynamically changed based on the initial state value, and a bit string of M sequence can be outputted from the changed linear feedback shift register. Hence, a cryptanalysis person cannot obtain the construction of the linear feedback shift register before the reconstruction based on pseudo-random numbers outputted from the pseudo-random number generator, and cannot cryptanalyze the initial state value and secret key. As a result, high encryption strength can be obtained and confidentiality of information can be kept.

The invention described in claim 2 is characterized in that the initial state value is processed by Hash function to find its Hash value to adopt, as the derived number, a prime number most approximated to the Hash value, in the method for generating pseudo-random numbers of claim 1.

According to this invention, since the initial state value is processed by Hash function to find its Hash value to adopt a prime number most approximated to the Hash value as the derived number, difficulty of estimating the derived value can be enhanced whereby confidentiality of information can be further increased.

The invention described in claim 3 is characterized in that the reconstruction of the linear feedback shift resistor is carried out using Berlekamp-Massay algorithm, in the method for generating pseudo-random numbers of claim 1 or 2.

This invention utilizes Berlekamp-Massay algorithm that the linear feedback shift register can be obtained from a bit string having bit number of at least two cycles.

The invention described in claim 4 is characterized in that the method comprises a eighth step for subjecting the pseudo-random numbers generated in the seventh step to nonlinear conversion, in the method for generating pseudo-random numbers of any of claims 1 to 3.

According to this invention, the pseudo-random numbers generated is nonlinearly conversed, and therefore nonlinearity can be given to the pseudo-random numbers, which enhances the encryption strength.

A pseudo-random numbers generator of the invention described in claim 5 comprises:

a linear feedback shift register having n shift resistors and capable of outputting a bit string having bit number of (2ˆn)-1 per one cycle;

means for setting up an initial state value of the linear feedback shift register based on a secret key;

means for finding a derived value prime to the bit number per one cycle of the linear feedback shift register based on the initial state value by means of a predetermined operation processing;

means for multiplying the derived value by a value obtained by multiplying the bit numbers per one cycle by two or more to calculate a bit number (of bit string) to be outputted from the first linear feedback shift register;

means for outputting a bit string corresponding to the calculated bit number based on the initial state value from the linear feedback shift register;

means for taking out a bit from the output bit string every the derived value to generate a new bit string;

means for reconstructing the linear feedback shift register such that the new bit string can be outputted from the resistor; and

means for generating pseudo-random numbers based on the initial state value from the linear feedback shift register changed in its construction.

In this invention, the bit string obtained by sampling, every a number s, bits of a bit string whose output sequence is M sequence, when the bit number (=(2ˆn)-1) per one cycle of the M sequence is prime to the derived value (s), constitutes M sequence of a linear feedback shift register having other construction. Further the invention utilizes that the linear feedback shift register can be determined from the bit string having bit number of at least two cycles.

According to the invention, the initial state value of the linear feedback shift register having n shift resistors and capable of outputting a bit string having bit number of (2ˆn)-1 per one cycle is set up, and the derived value prime to the bit number per one cycle of the linear feedback shift register based on the initial state value is determined by means of the predetermined operation processing.

Subsequently, the derived value is multiplied by a value obtained by multiplying the bit numbers corresponding to one cycle by two or more to calculate a bit number to be outputted from the first linear feedback shift register, a bit string corresponding to the calculated bit number is output based on the initial state value from the linear feedback shift register, and a bit is taken out from the output bit string every the number of the derived value to generate a new bit string.

Then, the construction of the linear feedback shift register is reconstructed such that the new bit string can be outputted from the resistor, and pseudo-random numbers are generated based on the initial state value from the reconstructed linear feedback shift register.

According to this method, the construction of the linear feedback shift register can be dynamically changed based on the initial state value, and a bit string of M sequence can be outputted from the changed linear feedback shift register. Hence, a cryptanalysis person cannot obtain the construction of the linear feedback shift register before the change based on pseudo-random numbers outputted from the pseudo-random number generator, and cannot cryptanalyze the initial state value and secret key. As a result, high encryption strength can be obtained and confidentiality of information can be kept.

In the pseudo-random number generator of claim 5, the invention described in claim 6 is characterized in that the generator is further provided with means for generating a second linear feedback shift resistor having construction capable of outputting a new bit string, instead of the means for changing construction of the linear feedback shift resistor; and the means for generating pseudo-random numbers generates the pseudo-random numbers based on the initial state value from the second linear feedback shift resistor.

According to this invention, the linear feedback shift resistor can be divided to two resistors, i.e., the first linear feedback shift resistor and the second linear feedback shift resistor, which brings about enhancement of confidentiality.

A pseudo-random number generator of the invention described in claim 7, comprising:

means for outputting a selectively used random number bit string having a predetermined bit number based on a secret key;

a random number table in which a plurality of amplified random bit strings having larger bit number than that of the selectively used random number bit string is (beforehand) recorded;

means capable of selecting a corresponding amplified random number bit string from the plurality of amplified random number bit strings within the random number table by referring to the random number table using the selectively used random number bit string (i.e., the random number bit string for selection) outputted from the means for outputting selectively used random number bit string; and

means (nonlinear conversion means) for nonlinearly conversing the amplified random number bit string selected by the means for selecting amplified random number bit string by a nonlinear function to output pseudo-random numbers.

According to this invention, since a selectively used random number bit string having a predetermined bit number is output based on a secret key, and a corresponding amplified random number bit string is selected from the plurality of amplified random number bit strings within the random number table by referring to the random number table using the selectively used random number bit string, the amplified random number bit string having a larger bit number can be obtained based on the selectively used random number bit string having small bit number.

Hence, the bit number of the bit string inputted into the nonlinear conversion means can be largely increased. Thereby, the throughput (which constitutes a hindrance so for) of means for outputting the random number bit string, which is provided on the upstream side compared with the nonlinear conversion means, can be enhanced and approximated to the throughput of the nonlinear conversion means, which brings about enhancement of the throughput of the whole pseudo-random number generator.

In the pseudo-random number generator of claim 7, the invention described in claim 8 is characterized in that the generator is further provided with means for generating the amplified random number bit string by a secret key given, storing the bit string in the random number table, and carrying out initial setup of the random number table.

According to this invention, the amplified random number bit string is generated by a secret key given, recorded in the random number table, and initial setup of the random number table is carried out, and therefore an initial state value within the random number table can be changed according to the change of the secret key. Hence the encryption strength can be enhanced.

In the pseudo-random number generator of claim 7 or 8, the invention described in claim 9 is characterized in that:

the means for outputting selectively used random number table are plurally provided,

the random number table is provided to correspond to each of the means for outputting selectively used random number table,

the means for generating the amplified random number bit string selects a corresponding amplified random number bit string from the random number table by referring to the random number table corresponding to each of the means for outputting selectively used random number bit string respectively using the selectively used random number bit strings outputted from each of the means for outputting selectively used random number bit string, and

the means for nonlinearly conversing outputs pseudo-random numbers by nonlinearly conversing the amplified random number bit string selected from each of the random number tables by nonlinear function using each of the means for generating the amplified random bit string.

According to this invention, the selectively used random number bit string is outputted from each of the means for outputting selectively used random number bit string, referred to each of the random number tables using each of the selectively used random number bit strings, and pseudo-random numbers is output by nonlinearly conversing the amplified random number bit string selected from each of the random number tables through the reference by nonlinear function. Therefore the throughput of the part outputting random number bit string (which constitutes a hindrance so for) can be increased, which brings about enhancement of the throughput of the whole pseudo-random number generator.

In the pseudo-random number generator of claim 9, the invention described in claim 10 is characterized in that plural random number tables are provided corresponding to each of the means for outputting selectively used random number bit string, and

the generator is further provided with means for subjecting each of the amplified random number bit strings selected from each of the random number tables by the means for selecting the amplified random number bit string to exclusive-or operation every the means for outputting a selectively used random number bit string and outputting to the nonlinear conversion means.

According to this invention, each of the amplified random number bit strings selected from each of the random number tables is subjected to exclusive-or operation every the means for outputting a selectively used random number bit string and outputted to a nonlinear conversion means. Therefore the bit string subjected to exclusive-or operation can enhance the encryption strength compared with the case of using a random number bit string outputted by the means for generating amplified random number bit string as it is.

In the pseudo-random number generator of claim 9 or 10, the invention described in claim 11 is characterized in that the generator is further provided with means for replacing the random number tables with each other at a predetermined time.

According to this invention, since the random number tables can be replaced with each other at a predetermined time, the random number tables used for the reference can be changed, which can enhance the encryption strength compared with the use of fixed random number tables.

In the pseudo-random number generator of claim 11, the invention described in claim 12 is characterized in that the means for replacing the random number tables has function of replacing the random number tables with each other, every time that the means for outputting a selectively used random number bit string outputs the selectively used random number bit string required for referring to each of the random number tables.

This invention shows an example of the predetermined time in the pseudo-random number generator of claim 12. According to the invention, since the random number tables are replaced with each other every time that the means for outputting a selectively used random number bit string outputs the selectively used random number bit string required for referring to each of the random number tables, the random number tables used for the reference can be changed at short intervals, which can further enhance the encryption strength.

In the pseudo-random number generator of claim 11 or 12, the invention described in claim 13 is characterized in that the means for replacing the random number tables has function of generating random numbers for replacing random number tables having the same number as the number of each of the random numbers, giving the random numbers for replacing random number tables to each of the random number tables as a table number of random number table, and replacing order of the random number tables according to a rule predetermined based on the table number.

This invention shows an example of the means for replacing the random number tables in the pseudo-random numbers generator of claim 13. According to the invention, random numbers for replacing random number tables are generated, the random numbers for replacing random number tables is given to each of the random number tables as a table number of random number table, and order of the random number tables is replaced according to a rule predetermined based on the table number. Hence, the order of the random number tables can be easily and rapidly replaced, and therefore the throughput on the upstream side compared with the nonlinear conversion means can be increased to approximate the throughput of the nonlinear conversion means, which brings about enhancement (enhanced speed) of the throughput of the whole pseudo-random number generator.

A program to be executed by a computer for generating pseudo-random numbers of the invention described in claim 14 comprising:

means for outputting a selectively used random number bit string having a predetermined bit number based on a secret key;

a random number table in which a plurality of amplified random number bit strings having a larger bit number than that of the selectively used random number bit string are stored;

means capable of selecting a corresponding amplified random number bit string from the plurality of amplified random number bit strings within the random number table by referring to the random number table using the selectively used random number bit string outputted from the means for outputting selectively used random number bit string; and

means for nonlinearly conversing the amplified random number bit string selected by the means for selecting amplified random number bit string by a nonlinear function to output pseudo-random numbers.

According to this invention, since a selectively used random number bit string having a predetermined bit number is output based on a secret key, a corresponding amplified random number bit string is selected from the plurality of amplified random number bit strings within the random number table by referring to the random number table using the selectively used random number bit string, and the amplified random number bit string is nonlinearly conversed by a nonlinear function to output pseudo-random numbers, the amplified random number bit string having a larger bit number can be obtained based on the selectively used random number bit string having small bit number.

Hence, the bit number of the bit string input into the nonlinear conversion means can be largely increased. Therefore, the throughput (which constitutes a hindrance so for) of means for outputting the random number bit string, which is provided on the upstream side in respect to the nonlinear conversion means, can be enhanced and approximated to the throughput of the nonlinear conversion means, which brings about enhancement of the throughput of the whole pseudo-random numbers generator.

In program for generating pseudo-random numbers of the invention described in claim 14, the invention described in claim 15 is characterized in that the program further has, as means for functioning the program, means for generating the amplified random number bit string by a secret key given, storing the bit string in a random number table, and carrying out initial setup of the random number table.

According to this invention, the amplified random number bit string is generated by a secret key given, recorded in the random number table, and initial setup of the random number table is carried out, and therefore an initial state value within the random number table can be changed according to the change of the secret key. Hence the encryption strength can be enhanced.

In program for generating pseudo-random numbers of the invention described in claim 14 or 15, the invention described in claim 16 is characterized in that, as means for functioning the program,

the means for outputting selectively used random number table are plurally provided, and

the random number table is provided to correspond to each of the means for outputting selectively used random number table, and

that the means for generating the amplified random number bit string selects a corresponding amplified random number bit string from each of the random number tables by referring to the random number table corresponding to every each of the means for outputting selectively used random number bit string using the selectively used random number table outputted from each of the means for outputting selectively used random number bit string, and

the means for nonlinearly conversing outputs a pseudo-random numbers by nonlinearly conversing the amplified random number bit string selected from each of the random number tables using each of the means for generating the amplified random number bit strings.

According to this invention, the selectively used random number bit string is outputted from each of the means for outputting selectively used random number bit string, each of the random number tables is referred using each of the selectively used random number bit strings, and pseudo-random numbers are output by nonlinearly conversing the amplified random number bit string selected from each of the random number tables through the reference by nonlinear function. Therefore the throughput of the part for outputting random number bit string (which constitutes a hindrance so for) can be increased, which brings about enhancement (enhanced speed) of the throughput of the whole pseudo-random number generator.

In program for generating pseudo-random numbers of the invention described in claim 16, the invention described in claim 17 is characterized in that, as means for functioning the program,

plural random number tables are provided every each of the means for outputting selectively used random number bit string, and further

the program has, as means for functioning the program, means for subjecting each of the amplified random number bit strings selected from each of the random number tables by the means for selecting the amplified random bit string to exclusive-or operation every the means for outputting selectively used random number bit string and outputting to a nonlinear conversion means.

According to this invention, each of the amplified random number bit strings selected from each of the random number tables is subjected to exclusive-or operation every the means for outputting selectively used random number bit string and output to a nonlinear conversion means. Therefore the bit string subjected to exclusive-or operation can enhance the encryption strength compared with the case of using a random number bit string output by the means for generating amplified random number bit string as it is.

In program for generating pseudo-random number of the invention described in claim 16 or 17, the invention described in claim 18 is characterized in that the program is, as means for functioning the program, further provided with means for replacing the random number tables with each other at a predetermined time.

According to this invention, since the random number tables can be replaced with each other at a predetermined time, the random number tables used as the reference can be changed, which can enhance the encryption strength compared with the use of fixed random number tables.

In program for generating pseudo-random numbers of the invention described in claim 18, the invention described in claim 19 is characterized in that the means for replacing the random number tables has function of replacing the random number tables with each other every time that the means for outputting the selectively used random number bit strings outputs the selectively used random number bit string required for referring to each of the random number tables.

This invention shows an example of the predetermined time in the program of claim 19. According to the invention, since the random number tables are replaced with each other every that the means for outputting the selectively used random number bit string outputs the selectively used random number bit string required for referring to each of the random number tables, the random number tables used as the reference can be changed at short intervals, which can further enhance the encryption strength.

In program for generating pseudo-random numbers of the invention described in claim 18 or 19, the invention described in claim 20 is characterized in that the means for replacing the random number tables has function of generating random numbers for replacing random number tables having the same number as the number of each of the random numbers, giving the random numbers for replacing random number tables to each of the random number tables as a table number of random number table, and replacing order of the random number tables according to a rule predetermined based on the table number.

This invention shows an example of the means for replacing the random number tables with each other in the program of claim 20. According to the invention, random numbers for replacing random number tables is generated, the random numbers for replacing random number tables is given to each of the random number tables as a table number of random number table, and order of the random number tables is replaced according to a rule predetermined based on the table number. Hence, the order of the random number tables can be easily and rapidly replaced, and therefore the throughput on the upstream side compared with the nonlinear conversion means can be increased and approximated the throughput of the nonlinear conversion means, which brings about enhancement (enhanced speed) of the throughput of the whole pseudo-random number generator.

### BRIEF DESCRIPTION OF THE DRAWINGS

FIG. 1 is a view explaining a pseudo-random number generator according to the embodiment of the present invention.

FIG. 2 shows an example of an initial polynomial of the linear feedback shift register according to the embodiment of the invention.

FIG. 3 is a flowchart explaining the processing of the pseudo-random number generator according to the embodiment of the invention.

FIG. 4 is a view schematically explaining a pseudo-random number generator according to the embodiment of the present invention.

FIG. 5 is a schematic view explaining the construction of a random number table.

FIG. 6 is a conceptive view explaining elements constructed in the random number bit string amplifying part.

FIG. 7 is a flowchart explaining the method for generating pseudo-random numbers according to the embodiment of the invention.

FIG. 8 is a conceptive view schematically showing the pseudo-random number generator according to the embodiment of the invention.

FIG. 9 is a conceptive view schematically showing the random number table.

FIG. 10 is a flowchart explaining the method for generating pseudo-random numbers according to the embodiment of the invention.

FIG. 11 shows an example of the initial polynomial of the linear feedback shift register according to the embodiment of the invention.

FIG. 12 is a flow chart explaining the reconstruction processing of the linear feedback shift register.

FIG. 13 is a table showing the result obtained by measuring the throughput.

FIG. 14 is a table showing parameter of NIST used in the verification.

FIG. 15 is a view showing the verified result of NIST.

FIG. 16 is a figure explaining a conventional stream cipher system.

FIG. 17 is a figure explaining the pseudo-random number generator of the encryption device.

FIG. 18 is a figure simply explaining a conventional structure of the linear feedback shift register.

### DETAILED DESCRIPTION OF THE PREFERRED EMBODIMENT

### First Embodiment

The first embodiment of the present invention is explained by referring to the drawings.

FIG. 1 is a view explaining a pseudo-random number generator 1 according to the first embodiment of the invention. In the embodiment, a nonlinear-combiner-type pseudo-random number generator 1 is explained as an example of the pseudo-random number generator.

The pseudo-random number generator 1 has an initial state value setting part (not shown) for setting an initial state value based on a secret key which is given by a user, plural pseudo-random number generating parts 10 for generating pseudo-random numbers based on the initial state value received from the initial state value setting part, and a nonlinear conversion part 20 which is connected to each of output sides of these plural pseudo-random number generating parts 10 and nonlinearly converses the pseudo-random numbers outputted from each of the pseudo-random number generating parts 10.

The initial state value setting part converts the secret key given by the user to a bit string, which is divided into the number of the pseudo-random number generating parts 10 and subjected to a processing for generating initial state values which are each assigned to a linear feedback shift register 11 of the pseudo-random number generating part 10.

The number L of the pseudo-random number generating parts 10 are arranged with each other in a row, and each of the parts 10 has the linear feedback shift register 11 and means 12 for reconstructing the linear feedback shift register.

The linear feedback shift register 11 has n shift registers capable of storing information of one bit and an exclusive-or circuit, similarly to one described in “Description of the Related Art”. In this embodiment, the construction of the shift register 11 is set beforehand such that a bit string (what is called M sequence) in which the bit number m per one cycle is (2ˆn)-1 , can be output.

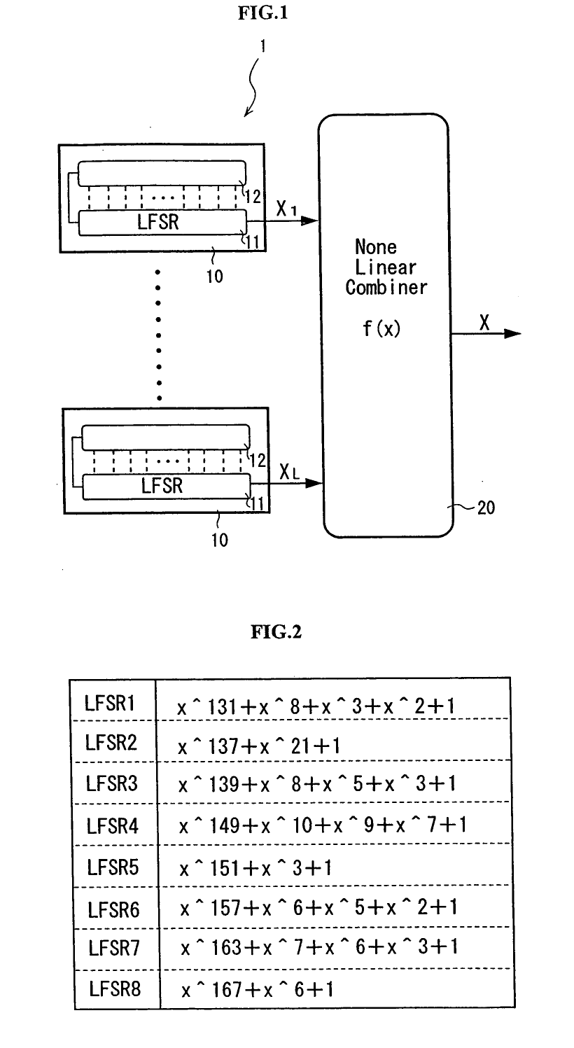

FIG. 2 shows an example of an initial polynomial of the linear feedback shift register 11 according to the embodiment of the invention. The initial polynomial is a characteristic polynomial set beforehand to output M sequence. An exponent part of the first member (which is represented by “ˆ” in FIG. 2) of the polynomial shows the number of the shift register(s) and the exponent parts of the second or more members show connection positions connected to the exclusive-or circuit. For example, it is shown that the linear feedback shift register 11 (LFSR1) illustrated in the first line of the Table has 131 of shift registers, and shift registers illustrated in the eighth, third and second lines are connected to the exclusive-or circuit through a feedback tap. In the embodiment, all of the number n of the shift registers are set to prime numbers.

The means 12 for reconstructing linear feedback shift register changes dynamically the construction of the linear feedback shift register to reconstruct it. In more detail, a new bit string obtained by sampling, every the number (s), bits of a bit string whose output sequence is M sequence, when the bit number (=(2ˆn)-1) per one cycle of the M sequence is prime to the derived value (s) (i.e., the bit number and derived value do not have common divisor other than 1 with each other), constitutes M sequence of a linear feedback shift register having other construction. Further a characteristic polynomial of the linear feedback shift register, that is capable of outputting the bit string and has equivalent and minimum construction, can be determined from a bit string of bits corresponding to at least two cycles by Berlekamp-Massay algorithm, whereby the linear feedback shift register can be reconstructed.

In the means 12 for reconstructing linear feedback shift register, the derived value s is calculated from the initial state value given by the initial state value setting part, the derived value is multiplied by a value 2m obtained by multiplying the bit number m (=(2ˆn)-1) corresponding to one cycle of the linear feedback shift register 11, and the bit number 2ms of the bit string to be outputted from the linear feedback shift register 11 is calculated.

Subsequently, 2ms (the number 2ms) of bits are output based on the initial state value from the linear feedback shift register 11, and a bit string is taken out from the 2ms of bits every the derived value s whereby new bit strings are generated, and then the linear feedback shift register 11 is reconstructed using the new bit strings by Berlekamp-Massay algorithm.

In the embodiment of the invention, though an example where the bit number of the bit string to be outputted from the linear feedback shift register 11 is 2ms is explained, the bit number is sufficient to have the number not less than 2ms because any bit numbers of not less than 2ms enable determination of the equivalent and minimum linear feedback shift register.

In the Berlekamp-Massay algorithm, bit string having a bit number of two or more times the number n (linear complexity) of the shift register of the linear feedback shift register 11 is obtained, whereby the equivalent and minimum linear feedback shift register capable of outputting the bit string can be obtained. The Berlekamp-Massay algorithm is fully described, for example, in “Introduction to Encryption Logic”, 2^{nd} edition, KYORITSU SYUPPAN, E. Okamoto, Apr. 10, 2002.

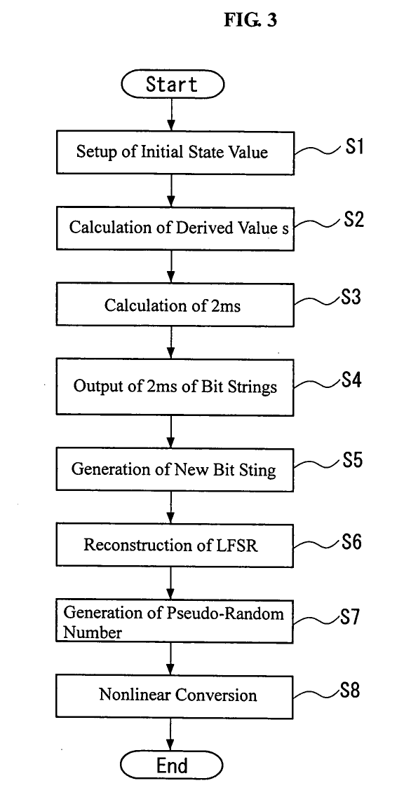

Subsequently, the processing (operation) of the pseudo-random number generator 1 having the above-mentioned construction is explained below by referring to a flowchart of FIG. 3.

First, the initial state value is set by the initial state value setting part (step 1). The initial state value is set by dividing the secret key given by a user by means of a predetermined operation processing.

For example, in case the length of the secret key is 16 bits consisting of “ABCDEFGHIJKLMNOP” and the pseudo-random number generating part 10 has eight lines, the initial state value is set in the following manner.

| | | |
|---|---|---|
| LFSR1 | AB + X‘FF’ | Padding (i.e., Padding Letter) |
| LFSR2 | CD + X‘FF’ | Padding |
| LFSR3 | EF + X‘FF’ | Padding |
| LFSR4 | GH + X‘FF’ | Padding |
| LFSR5 | IJ + X‘FF’ | Padding |
| LFSR6 | KL + X‘FF’ | Padding |
| LFSR7 | MN + X‘FF’ | Padding |
| LFSR8 | OP + X‘FF’ | Padding |

In the above lines, the initial state value is set by dividing the “ABCDEFGHIJKLMNOP” of the secret key to “AB”, “CD”, - - - “OP”, i.e., every two letters and imputing the two letters into the sift registers, and then padding the “Padding” into the reminder of the sift registers. The method for setting initial state value mentioned above is no more than one example, and the initial state value may be set by other methods.

When the initial state values are set by the secret key in the initial state value setting part, each of the initial state values is input to each of the pseudo-random number generating part 10 respectively to set within the shift register of the linear feedback shift register 11.

Subsequently, the linear feedback shift register 11I is reconstructed by the means for reconstructing linear feedback shift register 12 (step S2 to step S6).

First, the derived value s that is prime to the bit number m corresponding to one cycle of the linear feedback shift register 11 is calculated from the initial state value (step S2). The derived value s is determined by processing the initial state value by Hash function such as Message Digest 5 to find its Hash value and adopting a prime number most approximated to the Hash value. Hence, difficulty of estimating the derived value can be enhanced whereby confidentiality of information can be further increased. As long as the derived value s is determined from the initial state value and prime to the bit number m, the derived value s may be determined by any methods. However, the predetermined operation processing should be satisfactory in one way (property) in order to maintain confidentiality of information.

After the calculation of the derived value s, the bit number 2ms of the bit string to be outputted from the linear feedback shift register 11 is calculated (step S3). The bit number 2ms of the bit string to be outputted from the linear feedback shift register 11 can be determined by multiplying the derived value by a value obtained by multiplying the bit numbers (=(2ˆn)-1) corresponding to one cycle of the linear feedback shift register 11 by two or more.

Subsequently, a bit string having 2ms of bits are output based on the initial state value from the linear feedback shift register 11 (step S4), and a new bit string is generated from the resultant bit string (step S5). The new bit string is composed of bits taken out of the bit string having 2ms of bits every the derived values, and has the bit number of 2m.

The bit string taken out of the bits of M sequence every the number s (the derived value) is M sequence of the linear feedback shift register having other construction, provided that the bit number m per one cycle is prime to the derived value s each other. Therefore the new bit string is also M sequence.

Thereafter, the construction of the linear feedback shift register 11 is changed (reconstructed) based on the new bit string (step S6). The reconstruction of the linear feedback shift register 11 is conducted using Berlekamp-Massay algorithm. According to the Berlekamp-Massay algorithm, if a bit string having the bit number corresponding to two or more cycles is given, the equivalent and minimum linear feedback shift register capable of outputting the bit string can be determined. Therefore a characteristic polynomial of a new linear feedback shift register is derived from the new bit string having the bit number 2m, whereby the reconstruction is performed.

The reconstructed linear feedback shift register 11 has a characteristic polynomial having the same order as the register before the reconstruction and having the connection different from the register before the reconstruction. Thus, the reconstructed linear feedback shift register has a construction capable of outputting M sequence different from the register before the reconstruction, if the same initial state value as the register before the reconstruction is given to the reconstructed linear feedback shift register.

After the reconstruction of the linear feedback shift register 11 is completed by means 12 for reconstructing the linear feedback shift register, pseudo-random numbers are generated based on the initial state value from the reconstructed linear feedback shift register 11 (step S7). Thereby, the pseudo-random numbers of M sequence different from that before the reconstruction are generated from the pseudo-random number generating part 10.

The pseudo-random numbers outputted from the pseudo-random number generating part 10 are each inputted into the nonlinear conversion part 20, where each of the pseudo-random numbers is nonlinearly converted based on a predetermined nonlinear function f(x) (step S8). Thereby nonlinear property can be given to the pseudo-random numbers to further enhance the encryption strength.

According to the pseudo-random number generator 1 having the above-mentioned construction, the construction of the linear feedback shift register 11 can be easily and dynamically changed based on the initial state value and also after the change M sequence can be output. Hence, a cryptanalysis person cannot obtain the construction of the linear feedback shift register before the reconstruction. Therefore a known cryptanalysis method that can be formed on the assumption that the construction of the linear feedback shift register is already known is not formed. As a result, high encryption strength can be obtained and confidentiality of information can be kept.

In the above-mentioned embodiment, though the nonlinear-combiner-type pseudo-random number generator 1 is explained as an example, it is not necessary to restrict to the nonlinear-combiner-type. Any pseudo-random number generators using the linear feedback shift register, for example a pseudo-random number generator used in block cipher system can be employed.

Further, in the step S6, instead of reconstruction of the linear feedback shift register 11 based on the new bit string, a second linear feedback shift register having construction capable of outputting a new bit string is generated, and then, in the step S7, pseudo-random numbers may be generated based on the initial state value from the second linear feedback shift register. Thereby the linear feedback shift register can be divided into two to bring about enhancement of confidentiality. Furthermore, the pseudo-random number generator 1 of the first embodiment can be constructed by either software or hardware.

### Second Embodiment

Subsequently, the second embodiment of the present invention is explained by referring to the drawings.

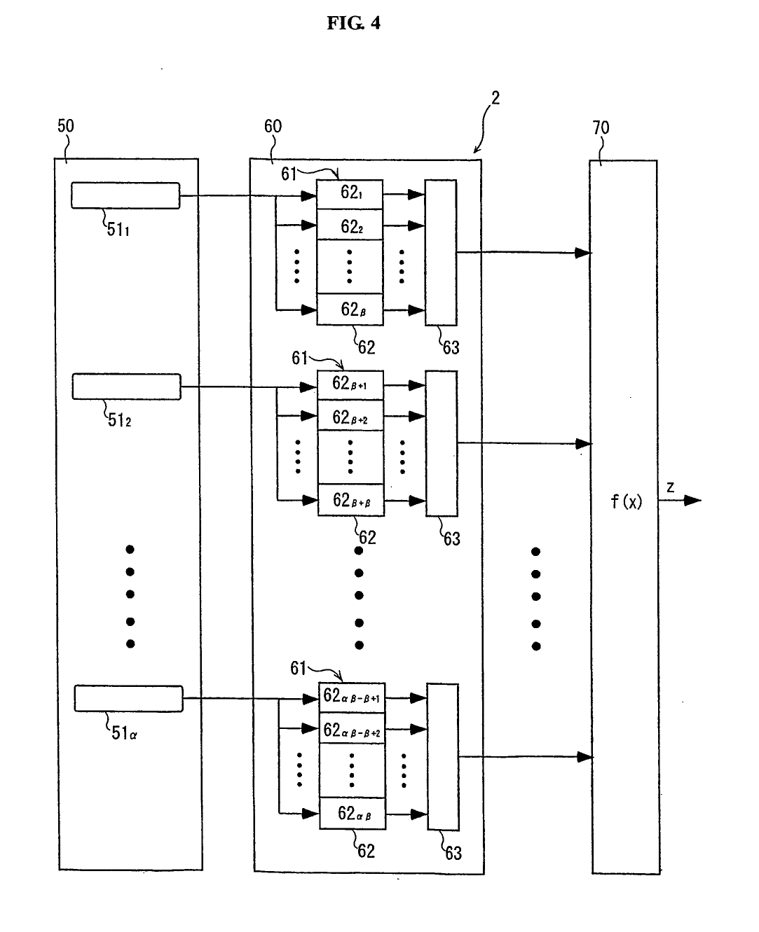

FIG. 4 is a view schematically explaining function of a pseudo-random number generator 1 according to the second embodiment of the invention. The pseudo-random number generator 1 of the embodiment is a nonlinear-combiner-type pseudo-random number generator 1 materiarized by running a pseudo-random number program on computer hardware. In the embodiment, the generator is explained only in the case of using in an encryption device (see Description of the Related Art), and the explanation is omitted in the case of using in a decryption device because the explanation is similar to that in the encryption device.

The pseudo-random number generator 1 has a random number bit string outputting part 50, a random number bit string amplifying part 60, and a nonlinear conversion part 80, as shown in FIG. 4. The random number bit string outputting part 50 is provided with a (the number) of means for outputting selectively used random number bit string 51. The means for outputting selectively used random number bit string 51₁ to 51_{α} continuously output the selectively used random number bit string having Ni bits based on a secret key having Lk bits given by a user, and is, for example, composed of linear feedback shift register(s).

The random number bit string amplifying part 60 is constructed so as to output the amplified random number bit string having No bits that is larger bit number than the Ni bits by the selectively used random number bit string of Ni bits being given, and further provided with a random number table 61 and means 63 for processing exclusive-or par operation.

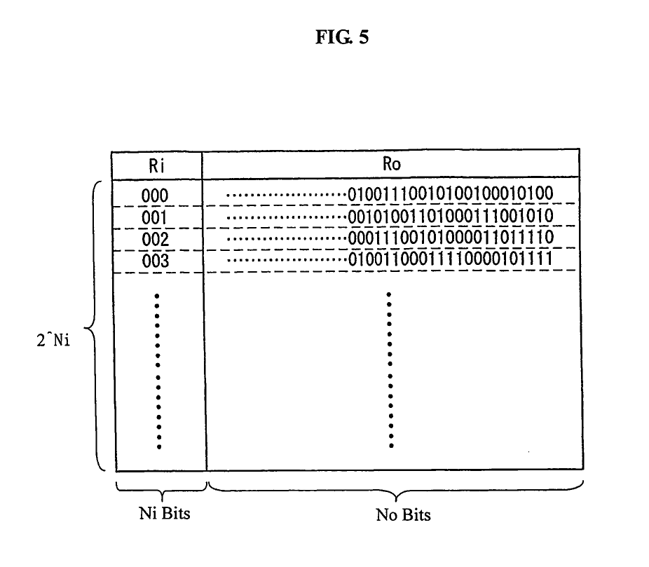

The random number table part 61 is constructed from α×β (hereinafter describes only “αβ”) of random number tables 62 storing (2ˆNi) of random bit strings. The β of random number tables 62 are provided every the means for outputting selectively used random number bit string 51, as shown in FIG. 4. FIG. 5 is a schematic view explaining the construction of one random number table. Each of the random number tables 62 has (2ˆNi) of index parts Ri to which index numbers of 0 to (2ˆNi)-1 are given and parts Ro for storing bit string which is capable of storing the above-mentioned amplified random number bit string and which is provided corresponding to each of the index numbers, as shown in FIG. 5.

Further the random number table is constructed in the following manner. The index number of the corresponding index part Ri is selected as argument a selectively used random number bit string selected from the means 51 for outputting selectively used random number bit string of the random number bit string outputting part 50, and the amplified random number bit string of No bits is selected from the parts Ro for storing bit string corresponding to the index numbers.

The means 63 for processing exclusive-or par operation is constructed such that from αβ of amplified random number bit strings extracted by the referring to the random number tables 62₁ to 62_{αβ} are subjected to the exclusive-or operation processing every the means 51 for outputting selectively used random number bit string, and the resultant a of amplified random number bit strings are output to the nonlinear conversion part 80. Thereby, the amplified random number bit strings read out from the random number tables 62₁ to 62_{αβ} are not output to the nonlinear conversion part 80 per se, but the encryption strength is prevented from depending upon the amplified random number bit string per se, and the strength is further enhanced.

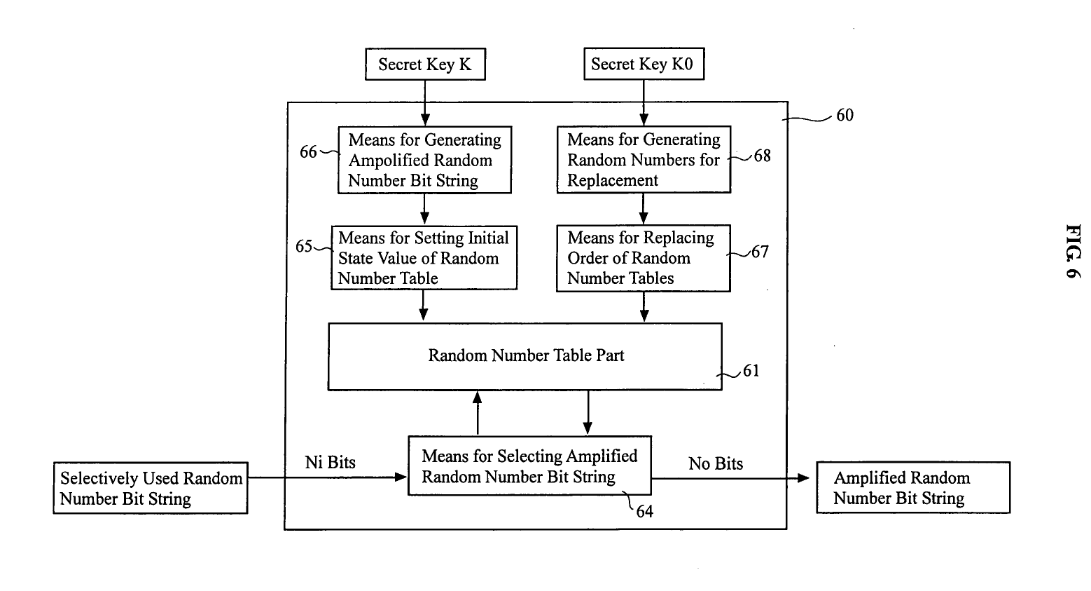

FIG. 6 is a conceptive view explaining elements constructing the Inside of the random number bit string amplifying part 60. The random number bit string amplifying part 60 is provided with means 64 for selecting amplified random number bit string as its inner mechanism as shown in FIG. 6. The means 64 for selecting amplified random number bit string is constructed such that, by referring to the random number tables 62₁ to 62_{αβ} using as argument the selectively used random number bit string outputted from the means 51₁ to 51_{α} for outputting selectively used random number bit string, the amplified random number bit string is selected from the bit storing part Ro corresponding to the index number having the same value as the argument.

Moreover, the random number bit string amplifying part 60 is provided with means 65 for initially setting random number table to conduct an initial setup of the random number table 61, and means 66 for generating amplified random number bit string to generate amplified random number bit string set within the random number table part 61 by the means 65 for initially setting random number table.

In the means 65 for initially setting random number table, the random number bit string generated by the means 66 for generating amplified random number bit string is divided every No bits, and stored in all the random number bit string storing parts Ro of the random number tables 62₁ to 62_{αβ}. In this embodiment, the random number table 62₁ corresponding to the means 51₁ for outputting selectively used random number bit string to the random number table 62_{αβ} corresponding to the means 51_{α} for outputting selectively used random number bit string are stored in order.

The means 66 for generating amplified random number bit string outputs the random number bit string based on the secret key K. In this embodiment, RC4 Syppetric Streap Cipher (available from RSA Data Security Inc.) is used. However, any means (mainly stream cipher) capable of outputting at high-speed pseudo-random number bit string such as linear feedback shift register can be used.

As shown in FIG. 6, the random number bit string amplifying part 60 is provided with means 67 for replacing random number tables each other having a function of replacing the order of the random number tables 62₁ to 62_{αβ}, and means 68 for generating random numbers for the replacement which generates random numbers for replacing the order used when the means 67 for replacing random number tables conducts the processing for replacing the order of random number tables.

The means 67 for replacing random number tables gives the random numbers for the replacement generated by the means 68 for generating random numbers for the replacement as a table number to the random number tables 62₁ to 62_{αβ} in the generation order, and replaces the order of the random number tables based on the given random numbers, and then the order of the amplified random number bit strings within the random number table 61 is changed every the table.

The means 68 for generating random numbers for the replacement is constructed in the following manner. The means 68 for generating random numbers for the replacement carries out the processing of generating the random numbers for replacing the random number tables based on an optional secret key K0, and generates αβ of random numbers for the replacement every input of a of random number bit strings having Ni bits from the random number bit string outputting part 50. In this embodiment, the optional secret key K0 uses the value corresponding to Lk bits taken out of the amplified random number bit string output by giving the secret key to the means 66 for generating amplified random number bit string. However, the secret key is not restricted to the above means, for example the secret key may be generated by other means, or input by a user.

The nonlinear conversion part 80 has a one-order no correlation nonlinear function f(x) having α input per one output. Further the nonlinear conversion part 80 is constructed such that a of random number bit strings outputted from the random number bit string amplifying part 60 is nonlinearly conversed and one random number bit string having No bits is output as the pseudo-random numbers Z.

The secret key K is selected from 128 bits, 256 bits, 512 bits and 1,024 bits, and the number α of the means 51 for outputting selectively used random number bit string, the number β of the random number table corresponding to each of the means 51 for outputting selectively used random number bit string and the bit number Ni of the selectively used random number bit string are selected under condition that they are multiplied one another and the resultant value is equal to the bit,number Lk of the secret key K.

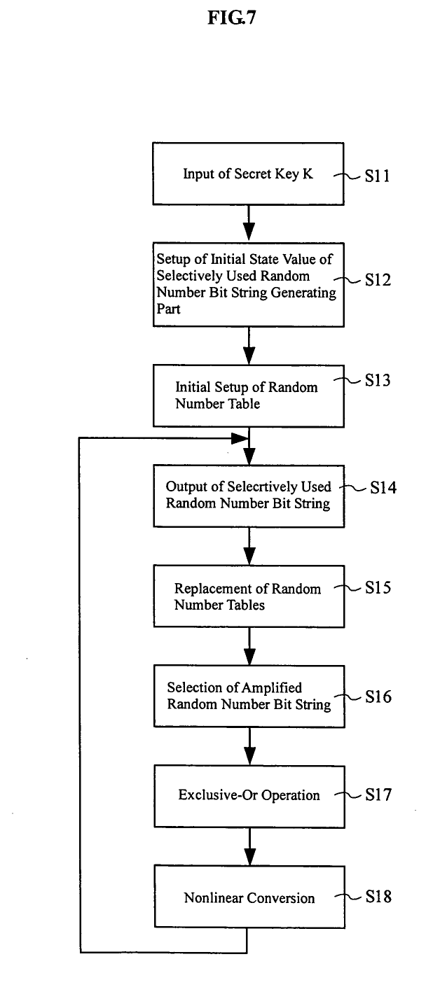

Subsequently, the method for generating pseudo-random numbers is explained by referring to FIG. 7. FIG. 7 is a flowchart explaining the method for generating pseudo-random numbers according to the embodiment of the invention.

First, when the a random number bit string outputting part 50 receives the input of an optional secret key K having Lk bits from a user (step S11), the outputting part 50 sets up the initial state value of the means 51 for outputting selectively used random number bit string 51 using the secret key K (step S12). For example, in case the means 51 for outputting selectively used random number bit string is constructed from the linear feedback shift registers, the initial state value stored within each of the shift registers is set up based on the secret key.

After the initial state value of the means 51 for outputting selectively used random number bit string is set up, the initial setup of the random number table 61 is carried out by the means 65 for initially setting random number table (step S13). In this case, the secret key is first given to the means 66 for generating amplified random number bit string to generate a random bit string at high speed. The bit string generated from the means 66 for generating amplified random number bit string are divided every No bits by the means 65 for initially setting random number table and stored in all of the parts Ro for storing random number bit string of each of the random number tables 62₁ to 62_{αβ} in order. Thus, the secret key is given, whereby the initial setup of the random number table 61 is carried out beforehand.

The setups of initial state values of the means 51 for outputting selectively used random number bit string and the random number table 61 are carried out by the above-mentioned steps S11 to S13, and thereafter they are in waiting state. When a plaintext in input to an encryption device (referring to “Description of the Related Art”), which acts as trigger, the amplified processing of the random number bit string is started (steps S14 to S16). First, the selectively used random number bit strings whose each has Ni bits are outputted by the number of β by the means 51 for outputting selectively used random number bit string to store in a random number bit string amplifying part 60 (step S14).

Subsequently, the order of the random number tables 62₁ to 62_{αβ} is replaced by the means 26 for replacing the order of the random number tables (step S15). In this case, the number αβ of random numbers for replacement are generated by the means 68 for generating random numbers for replacement, and given to each of the random number tables 62₁ to 62_{αβ} as table number for replacing the order of the random number tables. The table numbers are given from the random number table 62₁ to the random number table 62_{αβ} in the generated order.

Hence, the table numbers 1 to αβ are given to the random number tables 62₁ to 62_{αβ} in disorder. The order of the amplified random number bit strings within the random number table 61 is replaced every each of the random number table based on the given table number. Thereby the amplified random number bit strings within the parts Ro for storing random number bit string of the random number tables 61 are replaced every each of the each random table according to a predetermined rule such as ascending order or descending order.

After completion of the processing replacing the order of the random number tables 62₁ to 62_{αβ}, a corresponding amplified random number bit string is selected from each of the random number tables 62₁ to 62_{αβ} by the means 64 for selecting amplified random number bit string, whereby the processing for selecting amplified random number bit string is carried out (step S16). The means for selecting amplified random number bit string 64 refers to the corresponding random number tables 62₁ to 62_{αβ} using each of the random number bit strings stored within the random number bit string amplifying part 20, and the corresponding amplified random number bit string is selected from each of the random number tables 62₁ to 62_{αβ}.

After completion of the processing for selecting amplified random number bit string, the exclusive-or operation processing is carried out by the means 63 for processing exclusive-or operation (step S17). The means 63 for processing exclusive-or operation subjects αβ (the number) of amplified random number bit strings read out from each of the random number tables 62₁ to 62_{αβ} to the exclusive-or operation processing every each of the means 51 for outputting selectively used random number bit string. Thus, α (the number) of new amplified random number bit strings having No bits are generated.

Further, these new amplified random number bit strings are output to a nonlinear conversion part 80 whereby nonlinear conversion is performed. (step S18). The nonlinear conversion part 80 nonlinearly converts the αβ of amplified random number bit strings having No bits to output as pseudo-random numbers of one of the amplified random number bit strings having No bits

When the pseudo-random numbers are outputted from the nonlinear conversion part 80, the procedures from step S14 to step S18 are repeated again. Thus, pseudo-random numbers are generated to the extent required for conversing from the plaintext to ciphertext.

According to the pseudo-random number generator 1, the amplified random number bit strings having No bits lager in the bit number than Ni bits are fed to the nonlinear conversion part 80 by referring to the random number tables based on the selectively used random number bit strings having No bits outputted from the means 51 for outputting selectively used random number bit string. Hence, the throughput (which constitutes a hindrance so for) on the upstream side compared with the nonlinear conversion part 80 can be enhanced and approximated to the throughput of the nonlinear conversion part 80, which brings about enhancement of the throughput of the whole pseudo-random number generator 1.

In response to the input of the selectively used random number bit string from the means 20 for outputting selectively used random number bit string, the processing for replacing the order of random numbers is carried out. Therefore, encryption strength of the pseudo-random numbers can be enhanced. Especially, according to the embodiment of the invention, the number of combination of the random tables 62₁ to 62_{αβ} can be converted to that of factorial (hereinafter “factorial” is represented by “!”) of αβ. Hence, when it supposed that the random number tables 61 are known, effective attack requires calculation of (2ˆ(αβ×Ni))×(αβ)!. The amount of the calculation is larger than the calculation amount for searching the whole number of a secret key of Lk bits, and therefore sufficiently enhanced encryption strength is given.

Further, in the above-mentioned pseudo-random number generator 1, by referring to plural (β) of random number tables using the random number bit strings outputted from the means 51 for outputting selectively used random number bit string, the random number bit string selected from each of the random number tables are subjected to the exclusive-or processing. Hence, it is prevented that encryption strength depend on the means 66 for generating amplified random number bit string per se as the case that the amplified random number bit strings read out from the random number table part 61 are output per se to the nonlinear conversion part 80, and encryption strength is further enhanced.

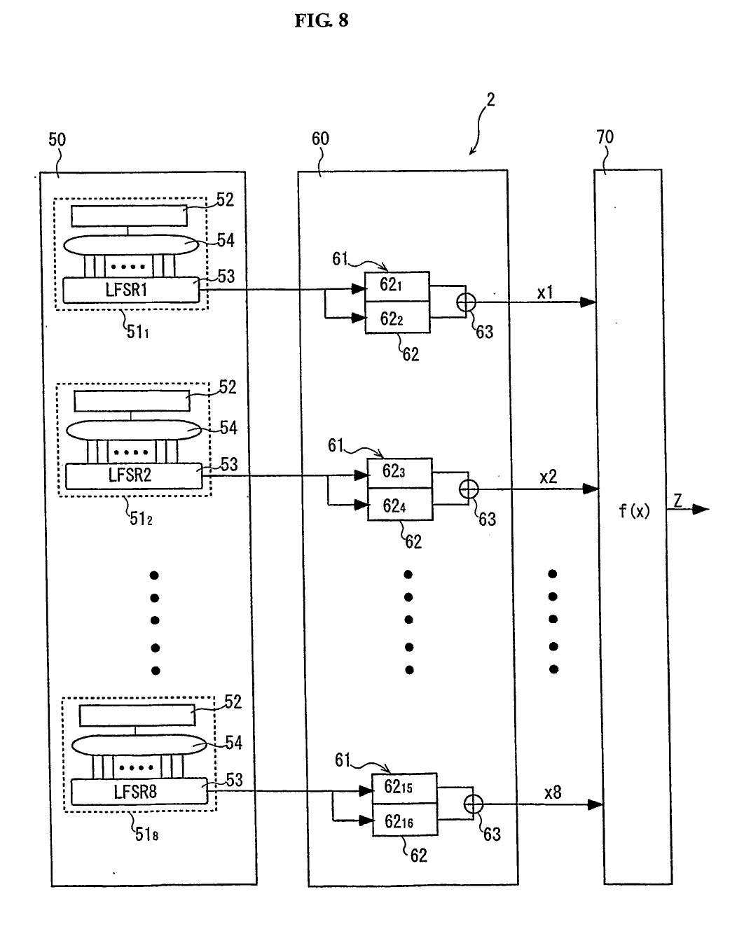

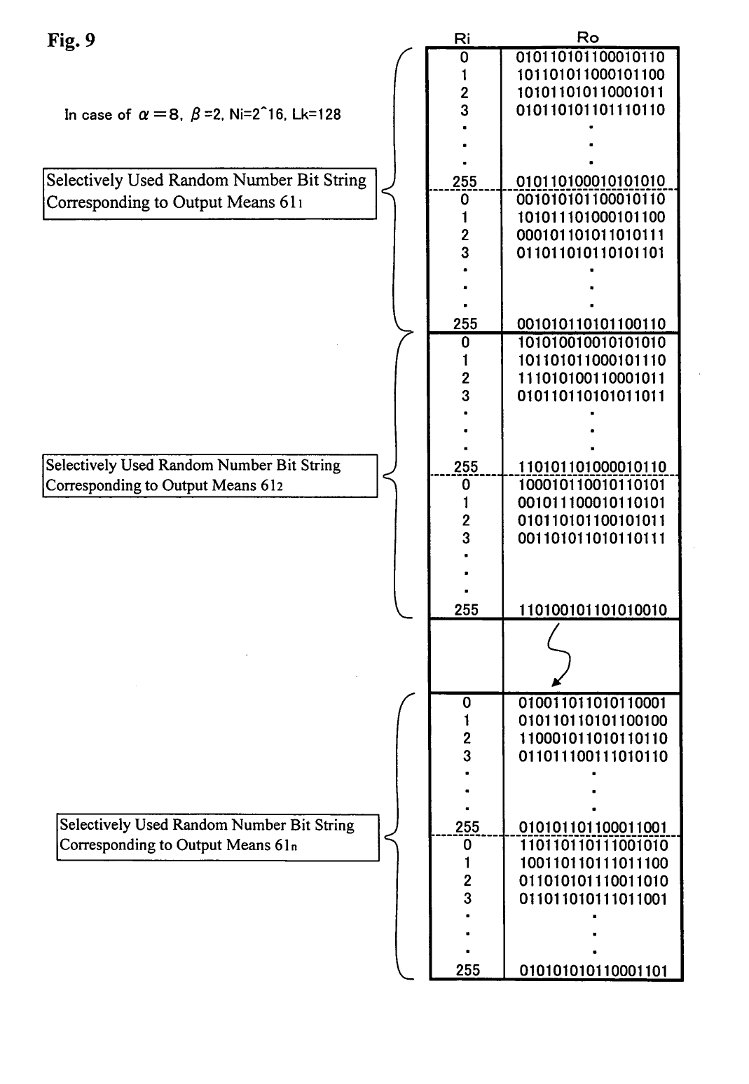

Subsequently, one example according to the embodiment of the invention is explained. FIG. 8 is a conceptive view schematically showing pseudo-random number generator 1 of the example. FIG. 9 is a conceptive view schematically showing the random number table 61. In the example, each setting value (parameter) is set in the following manner.

The number of means for outputting selectively used random number bit string:
8(α=8)

The number of the random number tables corresponding to each of means for outputting selectively used random number bit string:
2(β=2)

The length of the index part of the random number table:
2ˆ8(Ni=8)

The length of the random number bit string part of the random number table:
2ˆ16(No=16)

The length of the secret key:
128 bits(Lk=128)

The nonlinear function f(x) of the nonlinear conversion part 80:

$$f ( x ) = x1 + x5 + x1x2 + x1x3 + x2x3 + x2x5 + x2x6 + x3x6 + x1x7 + x2x7 + x4x8 + x5x8 + x1x2x3 + x1x2x4 + x1x3x4 + x2x3x4 + x1x2x5 + x2x4x5 + x3x4x5 + x1x2x6 + x2x3x6 + x1x4x6 + x4x5x6 + x1x2x7 + x2x3x7 + x1x4x7 + x1x5x7 + x2x5x7 + x4x5x7 + x1x6x7 + x4x6x7 + x5x6x7 + x1x2x8 + x1x3x8 + x2x3x8 + x3x4x8 + x1x5x8 + x3x5x8 + x4x5x8 + x3x6x8 + x4x6x8 + x5x6x8 + x1x7x8 + x2x7x8 + x1x2x4x5 + x1x3x4x5 + x2x3x4x5 + x1x2x4x6 + x1x3x4x6 + x2x3x4x6 + x1x4x5x6 + x2x4x5x6 + x3x4x5x6 + x1x2x3x7 + x1x2x4x7 + x2x3x4x7 + x1x2x5x7 + x1x4x5x7 + x2x4x5x7 + x1x2x6x7 + x1x3x6x7 + x2x3x6x7 + x1x4x6x7 + x2x4x6x7 + x3x4x6x7 + x1x5x6x7 + x2x5x6x7 + x3x5x6x7 + x1x2x4x8 + x1x2x5x8 + x1x3x5x8 + x1x4x5x8 + x1x2x6x8 + x2x3x6x8 + x1x4x6x8 + x2x5x6x8 + x3x5x6x8 + x1x3x7x8 + x1x4x7x8 + x2x4x7x8 + x3x4x7x8 + x2x5x7x8 + x1x2x3x4x5 + x1x2x3x4x6 + x1x3x4x5x6 + x2x3x4x5x6 + x1x2x4x5x7 + x2x3x4x5x7 + x1x2x4x6x7 + x1x3x4x6x7 + x1x4x5x6x7 + x2x4x5x6x7 + x1x2x3x4x8 + x1x2x3x5x8 + x1x2x4x5x8 + x1x2x3x6x8 + x1x2x4x6x8 + x1x3x4x6x8 + x2x3x5x6x8 + x1x4x5x6x8 + x2x4x5x6x8 + x1x2x3x7x8 + x1x3x4x7x8 + x1x3x5x7x8 + x2x3x5x7x8 + x3x4x5x7x8 + x1x3x6x7x8 + x3x4x6x7x8 + x1x2x3x4x5x8 + x1x2x3x4x6x8 + x1x3x4x5x6x8 + x2x3x4x5x6x8 + x1x2x3x4x7x8 + x1x2x3x5x7x8 + x1x2x4x5x7x8 + x1x3x4x5x7x8 + x1x3x4x6x7x8 + x2x3x4x6x7x8 + x1x2x5x6x7x8 + x1x3x5x6x7x8$$

In this example, the means 51 for outputting selectively used random number bit string reconstructs the linear feedback shift register 53 based on the secret key given by a user, and outputs the random number bit string using the reconstructed linear feedback shift register 53′.

First, the construction and operation of the means 51 for outputting selectively used random number bit string are explained. The means 51 for outputting selectively used random number bit string is provided with the means 12 for setting initial state value, the linear feedback shift register 53 and the means 14 for reconstructing linear feedback shift register, as shown in FIG. 8.

The means 12 for setting the initial state value, which sets up an initial state value based the secret key given by a user, converts the secret key K to a bit string, and assigns it as an initial state value into the inside of the shift register of the linear feedback shift register 53. In this example, as the means 12 for setting initial state value, RC4 Syppetric Streap Cipher (available from RSA Data Security Inc.) is used, and it is shared with the means 66 for generating amplified random number bit string.

The linear feedback shift register 53 has n of shift registers storing information of one bit and an exclusive-or operation circuit, similarly to one explained in “Description of the Related Art”. Further, in this embodiment, the register 53 is set beforehand to the construction capable of outputting a bit string having bit number m of (2ˆn)-1 per one cycle, what is called M sequence.

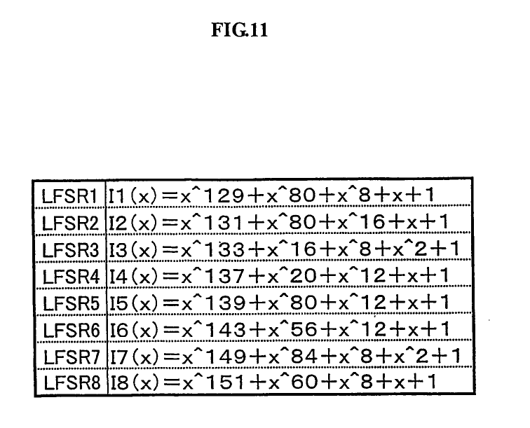

FIG. 11 shows an example of an initial polynomial of the linear feedback shift register 53 according to the embodiment of the invention. The initial polynomial is a characteristic polynomial which is set so as to output M sequence beforehand, and the exponent part in the first member of the characteristic polynomial represents the number of the linear feedback shift register, and the exponent parts in the second or more members represent the connection positions with the exclusive-or operation circuit. For example, the linear feedback shift register (LFSR1) 53 in the first line has 129 of shift registers, and the shift registers in 80^{th}, eighth and first lines are connected with the exclusive-or operation circuit through the feedback tap, as shown in FIG. 11. In this embodiment, all the number n of the shift registers is set to prime number.

The means 14 for reconstructing linear feedback shift register has a function of reconstructing the linear feedback shift register 53 by dynamically changing its construction by the secret key K. For example, a bit string obtained by sampling, every the number s, bits of a bit string whose output sequence is M sequence, when the bit number (=(2ˆn)-1) per one cycle of the M sequence is prime to the derived value (s) (i.e., they do not have divisors other than 1), constitutes M sequence of a linear feedback shift register having other construction. Further, the reconstruction of the linear feedback shift register 53 is carried out by utilizing that the characteristic polynomial of the linear feedback shift register, which is capable of outputting the bit string and has equivalent and minimum construction, can be obtained from the bit string having bit number of at least two cycles by means of Berlekamp-Massay algorithm.

In the means 14 for reconstructing linear feedback shift register, the derived value s is calculated from the initial state values given by the initial state value setting part 12, the derived value s is multiplied by a value 2m obtained by multiplying the bit number m (=(2ˆn)-1) corresponding to one cycle of the linear feedback shift register 53, and the bit number 2ms of the bit string to be outputted from the linear feedback shift register 53 is calculated.

Subsequently, 2ms (the number) of bit strings are output based on the initial state value from the linear feedback shift register 53, and a bit string is taken out from the 2ms of bit strings every the number of the derived value s whereby new bit strings are generated, and then the construction of the linear feedback shift register 11 is changed using the new bit strings by Berlekamp-Massay algorithm.

The bit number outputted from the linear feedback shift register 53 can have the number of not less than 2ms because any bit numbers of not less than 2ms enable determination of the equivalent and minimum linear feedback shift register.

In the Berlekamp-Massay algorithm, bit string having a bit number of two or more times the number n (linear complexity) of the shift register of the linear feedback shift register 53 is obtained, whereby the equivalent and minimum linear feedback shift register capable of outputting the bit string can be obtained. The Berlekamp-Massay algorithm is fully described, for example, in “Introduction to Encryption Logic”, 2^{nd} edition, KYORITSU SYUPPAN, E. Okamoto, Apr. 10, 2002.

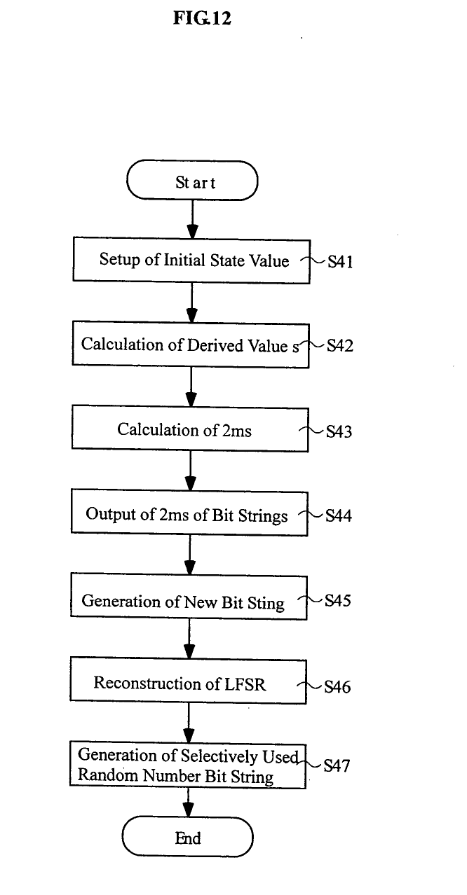

FIG. 12 is a flow chart for explaining the reconstruction processing of the linear feedback shift register 53. First, the initial state value is set by the means 12 for setting the initial state value (step S41). The initial state value is set based on the secret key K of Lk bit given by a user. When the initial state value is set by the secret key in the means 12 for setting the initial state value, the initial state value is set within the shift register of the linear feedback shift register 53.

Subsequently, the derived value s that is prime to the bit number m per one cycle of the linear feedback shift register 53 is calculated from the predetermined operation processing (step S42). The derived value s is determined by processing the initial state value by Hash function such as Message Digest 5 to determine its Hash value and selecting a prime number most approximated to the Hash value. Provided that the derived value s can be determined from the initial state value and prime to the bit number m with each other, the derived value s may be determined by any methods. However, the predetermined operation processing should satisfy one way (property) in order to maintain confidentiality of information.

After the calculation of the derived value s, 2ms of bit number of the bit string to be outputted from the linear feedback shift register 53 is calculated (step S43). The bit number 2ms of the bit string to be outputted from the linear feedback shift register 53 can be determined by multiplying the derived value by a value obtained by multiplying the bit numbers (=(2ˆn)-1) per one cycle of the linear feedback shift register 53 by two or more.

Subsequently, a bit string having 2ms of bit number are output based on the initial state value from the linear feedback shift register 53 (step S44), and a new bit string is generated from the resultant bit string (step S45). The new bit string is composed of bits taken out of the bit string having 2ms of bit number every the derived value, and has the bit number of 2m.

The bit string taken out of the bit string of M sequence every the number s (the derived value) is M sequence of the linear feedback shift register having other construction, provided that the bit string m per one cycle is prime to the derived value s each other. Therefore the new bit string is also M sequence.

Thereafter, the construction of the linear feedback shift register 53 is changed (reconstructed) based on the new bit string (step S46). The reconstruction of the linear feedback shift register 53 is conducted using Berlekamp-Massay algorithm. According to the Berlekamp-Massay algorithm, if a bit string having the bit number corresponding to two or more cycles is given, the equivalent and minimum linear feedback shift register 53 capable of outputting such a bit string can be obtained. Therefore a new characteristic polynomial of linear feedback shift register 53 is derived from the new bit string having the bit number of 2m, whereby the reconstruction is performed.

The reconstructed linear feedback shift register 53′ has a characteristic polynomial having the same order as the register before the reconstruction and having the connection different from the register before the reconstruction. Thus, the reconstructed linear feedback shift register has a construction capable of outputting N sequence different from the register before the reconstruction, if the same initial state value as the register before the reconstruction is given to the reconstructed linear feedback shift register.

After the reconstruction of the linear feedback shift register 53 is completed by means 14 for reconstructing the linear feedback shift register, a random number bit string for the selection is generated based on the initial state value from the reconstructed linear feedback shift register 53′ (step S47). Thereby, the random number bit string for the selection of M sequence different from that before the reconstruction is generated from the random number generating part 50.

In the above-mentioned step S46, instead of the reconstruction of the linear feedback shift register 53 based on the new bit string, a second linear feedback shift register having a construction capable of outputting a new bit string is generated, and in the step S47, the random number bit string can be generated based on the initial state value by the second linear feedback shift register. Thereby the linear feedback shift register can be divided to two, and confidentiality of information can be enhanced.

In the pseudo-random number generator 51 having the above-mentioned construction, the construction of the linear feedback shift register 53 can be easily and dynamically changed based on the initial state value, and also from the changed construction, M sequence can be outputted. Hence, a cryptanalysis person cannot obtain the construction of the linear feedback shift register before the reconstruction. Therefore a known cryptanalysis method that can be formed on the assumption that the construction of the linear feedback shift register is already known is not formed. As a result, high encryption strength can be obtained and confidentiality of information can be kept.

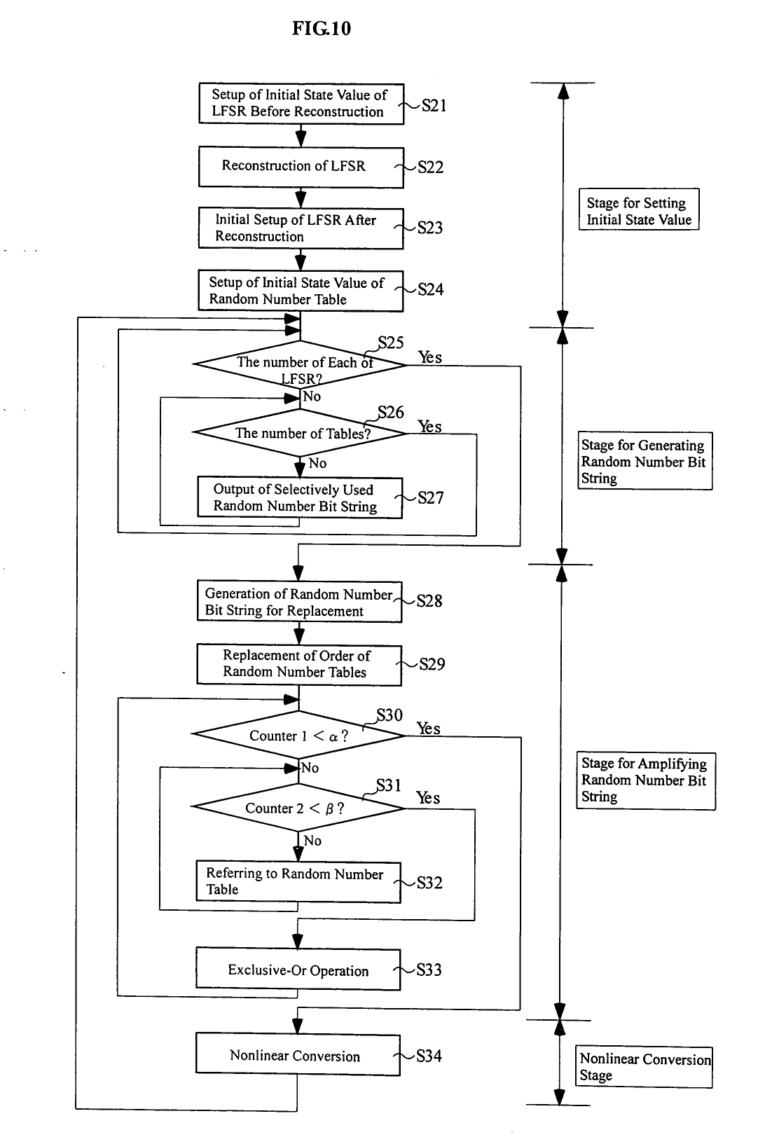

Subsequently, the method for generating pseudo-random numbers using the pseudo-random number generator 1 provided with the means 51 for outputting selectively used random number bit string is explained. FIG. 10 is a flowchart explaining the method for generating pseudo-random numbers according to the embodiment of the invention.

First, when the a random number bit string outputting part 50 receives the input of an optional secret key K having 128 bits (Lk=128 bits) from a user, an initial state value of the linear feedback shift register 53 before the reconstruction is set based on the secret key K (step S21).

Then, the linear feedback shift register 53 is reconstructed based on the initial state value (step S22), and an initial state value of the reconstructed linear feedback shift register 53′ is set up (step S23). The setup of the initial state value is performed in the respect to all the means for outputting random number bit string 11₁ to 11₈.

Subsequently, a random number bit string outputting part 60 conducts an initial setup of a random number table 61 (step S24). In this case, the secret key K is first given to means 66 for generating amplified random number bit string and the processing of generating a random bit string is carried out at high speed. In this example, since the means 66 for generating amplified random number bit string is shared with the means for setting initial state value 12 of the means 51 for outputting selectively used random number bit string, as mentioned above, the random bit string output as the initial state value from the linear feedback shift register 53 is used as it is, without outputting the bit string separately.

The means 65 for initially setting random number table divides the random bit string every 16 bits (No=16), and storing the divided bit strings in all the random number bit string storing parts Ro of each of the random number tables 62₁ to 62₁₆ in order.

After the initial setup stage (steps 21 to 24) mentioned above, the processing are in waiting state. When the completion of a plaintext is inputted to an encryption device (referring to “Description of the Related Art”), which acts as trigger, the processing of generating pseudo-random numbers is transferred (steps S25 to S27).

Here, the selectively used random number bit string is output every each of the means 51₁ to 51₈ for outputting selectively used random number bit string, and stored in a buffer of the random number bit string amplifying part 60. In more detail, the selectively used random number bit string of 8 bits is outputted from each of the means 51₁ to 51₈ for outputting selectively used random number bit string (step S27). The number of the selectively used random number bit string is two (β=2) for each of the means 1 for outputting selectively used random number bit string (Yes in the step S26). In case it is corresponded to each of the means 51₁ to 51₈ for outputting selectively used random number bit string (Yes in the step S25), the processing moves to the subsequent random number bit string amplifying stage by considering that the required selectively used random numbers are obtained. Hence, 16 of selectively used random number bit strings having 8 bits are stored in the buffer by the processing mentioned above.

Subsequently, 16 of random numbers for replacement are generated based on the secret key K0 by the means 68 for generating random numbers for replacement (step S28), and the processing for replacing the order of random number tables is carried out (step S29). In this case, the 16 of random numbers are given to the random number tables 62₁ to 62₁₆ as a table number. Hence, the table numbers of No. 1 to No. 16 are given to the random number tables 62₁ to 62₁₆ in disorder. Further, the order of the random number tables 62₁ to 62₁₆ is replaced based the given table numbers. Here, the replacement in the descending order is carried out such that the table numbers of No. 1 to No. 16 are arranged to the means 51₁ to 51ₙ for outputting selectively used random number bit string in the order of No. 1 to No. 16. Thereby the order of the amplified random number bit strings within the random number tables 61 are randomly replaced every each of the random number tables.

Subsequently, the processing that the corresponding amplified random number bit string is selected from each of the random number tables 62₁ to 62₁₆ is carried out (steps S30 to S32). For example, the processing is referred to the random number table 62₁ by using a first selectively used random number bit string outputted from the selectively used random number bit string 11₁ and stored in the buffer as an argument (step S32). Then the index number having the same value as the argument is selected, and the random number bit string stored in the random number bit string storing part Ro corresponding to the index number is selected.

For example, when the random number bit string stored in the random number bit string storing part Ro that corresponds to the random number table 62₁ outputted from the means 51₁ for outputting selectively used random number bit string is “00000011”, the “00000011” is considered to be binary number of eight figures and converted to a value of decimal number to obtain “3” of the argument. The amplified random number bit string “010110101101110110” having the index number (of the index part Ro) of 3 stored in the random number bit string storing part Ro is selected by referring to the random number table 62₁ using this argument “3”.

Then, when the amplified random number bit string is selected from the random number table 62₁ and the random number table 62₂ respectively (Yes in the step S31), the two amplified random number bit strings are subjected to the exclusive-or operation processing (step S33) to generate a new amplified random number bit string having 16 bits.

Subsequently, after the same processing as described above is carried out for the random number tables 62₃ to 62₁₆ (Yes in the step S30) whereby a total of eight new amplified random number bit strings are generated, they are outputted to the nonlinear conversion part 80 and transferred to the nonlinear conversion stage.

In the nonlinear conversion part 80, input of the eight new amplified random number bit strings having No bits from the random number bit string amplifying part 60 brings about nonlinear conversion of the bit strings by the nonlinear function f(x) (step S34) to give one random number bit string having 16 bits. Then, the processing of the steps S25 to S34 are repeatedly performed whereby a required number of pseudo-random numbers are obtained.

In this example, an experiment on whether high speed property and randomness are appropriately kept or not was carried out. As a result, the processing speed was increased to 180 times that of a conventional processing, and simultaneously an appropriate randomness was acquired. The experiment and result are described below.

A computer used in the experiment is CPU: Pentium (registered trademark) 4 having 1.7 GHz and memory of 256 MB. Each of the setting values are the same as the above-mentioned example. The secret key K0 used in the means 28 for generating random number bit strings for replacement is (f1e2d3c4b5a69788796a5b4c3d2e1f10)₁₆ represented by 16 hexadecimal number, and the experiment is carried out by fixing this value.

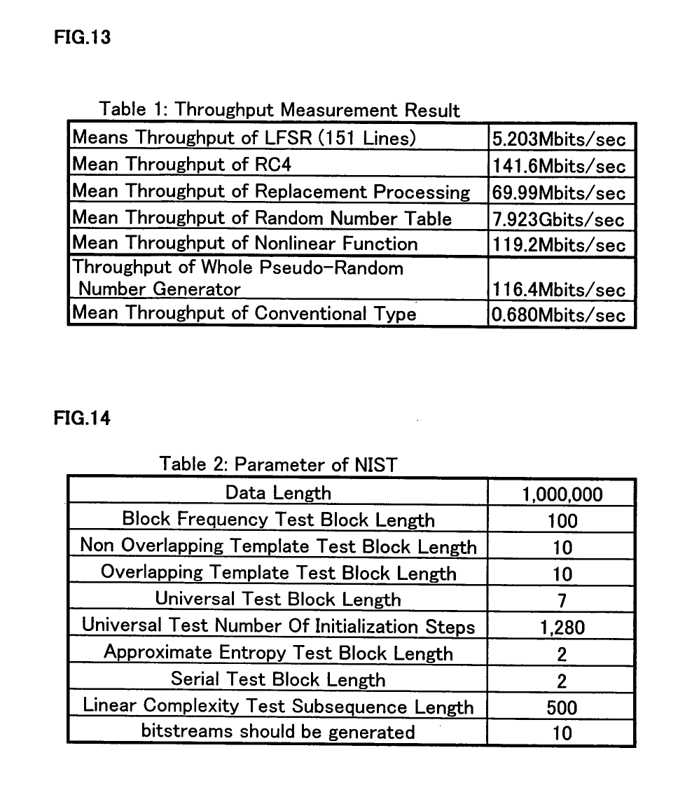

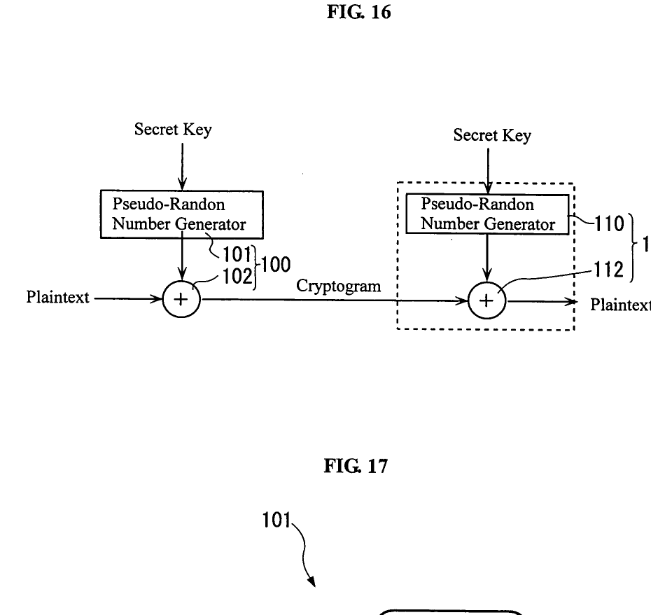

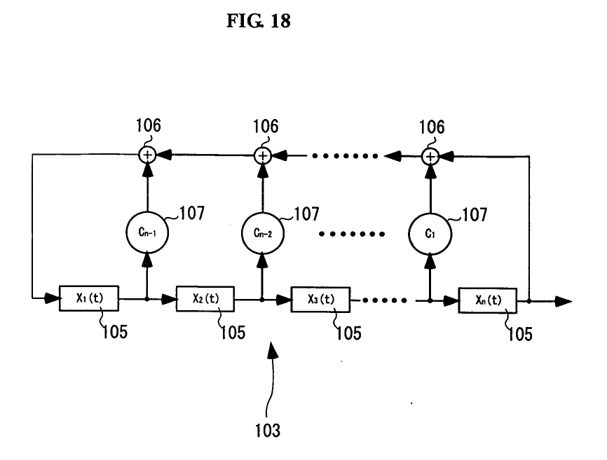

FIG. 13 is a table showing the result obtained by measuring the throughput. The conventional type in the Table is the nonlinear-combiner-type pseudo-random number generator as shown in FIG. 17 which is composed of eight of linear feedback shift registers (LFSR) 53 and a nonlinear conversion part 80.

According to the experimental result, a mean throughput of the pseudo-random number generator 1 is enhanced from a mean throughput of the linear feedback shift registers 53 as it is to that of nonlinear conversion part 80, and the enhanced throughput is about 170 times (i.e., 116.4 Mbps/sec÷0.680 Mbps/sec=171.176 - - - ) that of the conventional type. Hence, the throughput result shows that the use of the random number table 62 is effective to enhance processing speed of the pseudo-random number generator 1.

The throughput of the pseudo-random number generator 1 used in the example is represented the following formula:

$$\frac{1}{T} = \frac{{N}_{I}}{{N}_{O}} ( \frac{n}{{T}_{1}} + \frac{1}{{T}_{2}} + \frac{1}{{T}_{3}} ) + \frac{n m}{{T}_{4}} + \frac{1}{{T}_{5}} . \qquad ( 1 )$$

In the formula (1), T1 represents a mean throughput of one linear feedback shift registers 53, T2 represents a mean throughput of RC4 (means 66 for generating amplified random number bit string), T3 represnets a mean throughput of the processing for replacing random number tables by the means 67 for replacing random number tables, T4 represents a mean throughput of one random number table, and T5 represents a mean throughput of the nonlinear conversion part 80. On the assumption that the calculated amount of the random number table 62 can be neglected from the formula (1), the throughput of the pseudo-random number generator 1 can be brought close to that of the nonlinear conversion part 80 with reduction of a ratio (No bits/Ni bits), whereby the processing can be further enhanced.

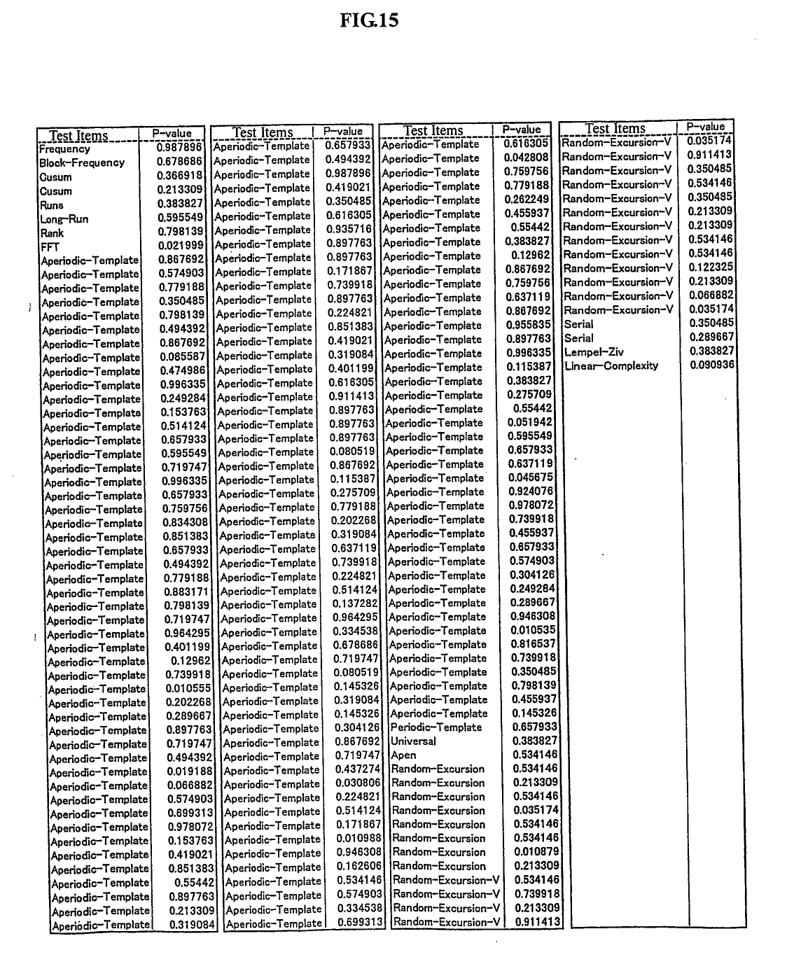

In contrast, the encryption strength of pseudo-random numbers is verified using a tool for verifying pseudo-random numbers of NIST (general name). The NIST is a tool for performing a test of randomness on physical random numbers and output data from a pseudo-random number generator, and also a statistical package including 16 tests. The NIST is explained in detail in “http://crsc.nist.gov/rug”. FIG. 14 is a table showing parameter of NIST used in the verification. When p-value outputted by conducting the various tests satisfies the condition of 0<p-value<1, it is considered that the corresponding tests are passed. The pseudo-random numbers of the pseudo-random number generator 1 according to this example was verified, and consequently it was confirmed that all the tests were passed. FIG. 15 is a view showing the verified result of NIST in this experiment.

However, the setup (setting) values shown in the example are set in order to confirm security of cryptograph, and therefore any value other than the setup values can be set up. Further, the invention is not restricted to the embodiments described above, but various changes and combinations can be adopted so long as they are not deviated from the scope of the invention.

### 5. EFFECT OF THE INVENTION

As described above, a bit string obtained by sampling, every the number s, bits of a bit string whose output sequence is M sequence, when the bit number (=(2ˆn)-1) per one cycle of the M sequence is prime to the derived value, constitutes M sequence of a linear feedback shift register having other construction. Further, the linear feedback shift register can be determined from bits corresponding to at least two cycles by Berlekamp-Massay algorithm, whereby the linear feedback shift register can be dynamically reconstructed based on the initial state value, and the bit string of the M sequence can be outputted from the reconstructed linear feedback shift register.

Hence, a cryptanalysis person cannot obtain the construction of the linear feedback shift register before the reconstruction based on the pseudo-random numbers outputted from the pseudo-random number generator. Therefore a known cryptanalysis cannot cryptanalyze the initial state value and the secret key. As a result, high encryption strength can be obtained and confidentiality of information can be kept.

Further, according to another embodiment of the invention, since a selectively used random number bit string having a predetermined bit number is output based on a secret key, and a corresponding amplified random number bit string is selected from a plurality of amplified random number bit strings within the random number table using the selectively used random number bit string by referring to the random number table, the amplified random number bit string having a larger bit number can be obtained based on the selectively used random number bit string having small bit number.

Hence, the bit number of the bit string inputted into the nonlinear conversion means can be largely increased. Therefore, the throughput (which constitutes a hindrance so for) of means for outputting the random number bit string, which is provided on the upstream side compared with the nonlinear conversion means, can be enhanced and approximated to the throughput of the nonlinear conversion means, which brings about enhancement of the throughput of the whole pseudo-random number generator.

### EXPLANATION OF REFERENCE NUMBER

1 Pseudo-random number generator
10 Pseudo-random number generating part
11 Linear feedback shift register
12 Means for reconstructing the linear feedback shift register
20 Nonlinear conversion part
50 Random number bit string outputting part
51 Means for outputting selectively used random number bit string
52 Means for setting initial state value
53 Linear feedback shift register
54 Means for reconstructing linear feedback shift register
60 Random number bit string amplifying part
61 Random number table part
62₁ to 62_{αβ} Random number tables
63 Means for processing exclusive-or par operation
64 Means for selecting amplified random number bit string
65 Means for initially setting random number table
66 Means for generating amplified random number bit string
67 Means for replacing the order of random number tables
68 Means for generating random numbers for replacement
70 Nonlinear conversion part

1. A method for generating pseudo-random numbers comprising:
a first step for setting up an initial state value of a linear feedback shift register including n plurality of shift resistors and capable of outputting a bit string having bit number of (2ˆn)-1 per one cycle;
a second step for finding a derived value prime to the bit number per one cycle of the linear feedback shift register based on the initial state value by means of a predetermined operation processing;
a third step for multiplying the derived value by a value obtained by multiplying the bit number per one cycle by two or more to calculate a bit number to be outputted from the linear feedback shift register;
a fourth step for outputting a bit string corresponding to the calculated bit number based on the initial state value from the linear feedback shift register;
a fifth step for taking out a bit from the output bit string to generate a new bit string;
a sixth step for reconstructing the linear feedback shift register such that the new bit string can be outputted from the resistor; and
a seventh step for generating pseudo-random numbers based on the initial state value from the reconstructed linear feedback shift register.

2. A method for generating pseudo-random numbers as defined in claim 1, wherein the initial state value is processed by Hash function to determine its Hash value to adopt a prime number most approximated to the Hash value as the derived number.

3. A method for generating pseudo-random numbers as defined in claim 1, wherein the reconstruction of the linear feedback shift resistor is carried out using Berlekamp-Massay algorithm.

4. A method for generating pseudo-random numbers as defined in any of claims 1, which further comprises an eighth step for subjecting the pseudo-random numbers generated in the seventh step to nonlinear conversion.

5. A pseudo-random number generator comprising:
a linear feedback shift register having n shift resistors and capable of outputting a bit string having bit number of (2ˆn)-1 per one cycle;
means for setting up an initial state value of the linear feedback shift register based on a secret key;
means for determining a derived value prime to the bit number per one cycle of the linear feedback shift register based on the initial state value by means of a predetermined operation processing;
means for multiplying the derived value by a value obtained by multiplying the bit number corresponding to one cycle by two or more to calculate a bit numbers to be outputted from the first linear feedback shift register;
means for outputting a bit string corresponding to the bit number calculated by the above means based on the initial state value from the linear feedback shift register;
means for taking out a bit from the output bit string every the number of the derived value to generate a new bit string;
means for reconstructing the linear feedback shift register such that the new bit string can be outputted from the resistor; and
means for generating pseudo-random numbers based on the initial state value from the reconstructed linear feedback shift register.

6. A pseudo-random number generator as defined in claim 5, which is further provided with means for generating a second linear feedback shift resistor having construction capable of outputting a new bit string, instead of the means for reconstructing the linear feedback shift resistor; and wherein the means for generating pseudo-random numbers generates the pseudo-random numbers based on the initial state value from the second linear feedback shift resistor.

7. A pseudo-random number generator comprising:
a part for outputting a selectively used random number bit string having a predetermined bit number based on a secret key;
a part for outputting an amplified random number bit string having bits of a larger bit number than the selectively used random number bit string based on the selectively used random number bit string outputted from the part for outputting a selectively used random number bit string; and
a part for nonlinearly converting the amplified random number bit string outputted from the part for outputting an amplified random number bit string to output pseudo-random numbers;
said part for outputting a selectively used random number bit string comprising:
a linear feedback shift register having n shift resistors and capable of outputting a bit string having bit number of (2ˆn)-1 per one cycle,
means for setting up an initial state value of the linear feedback shift register based on a secret key,
means for determining a derived value prime to the bit number per one cycle of the linear feedback shift register based on the initial state value by means of a predetermined operation processing,
means for multiplying the derived value by a value obtained by multiplying the bit number corresponding to one cycle by two or more to calculate a bit numbers to be outputted from the linear feedback shift register,
means for outputting a bit string corresponding to the bit number calculated by the above means based on the initial state value from the linear feedback shift register.
means for taking out a bit from the output bit string outputted from the above means every the number of the derived value to generate a new bit string,
means for reconstructing the linear feedback shift register such that the new bit string can be outputted from the resistor, and
means for outputting selectively used pseudo-random numbers based on the initial state value using the reconstructed linear feedback shift register reconstructed by the above means;
said part for outputting an amplified random number bit string comprising:
a random number table in which a plurality of amplified random bit strings having larger bit number than that of the selectively used random number bit string is stored, and
means capable of selecting a corresponding amplified random number bit string from the plurality of amplified random number bit strings within the random number table by referring to the random number table using the selectively used random number bit string outputted from the means for outputting selectively used random number bit string; and
said part for nonlinearly converting the amplified random number bit string comprising means for nonlinearly converting the amplified random number bit string selected by the means for selecting the amplified random number bit string by a nonlinear function to output pseudo-random numbers.

8. A pseudo-random number generator as defined in claim 7, wherein said part for outputting an amplified random number bit string comprises means for generating the amplified random number bit string by a secret key given, and means for storing the amplified random bit string generated from the above means in the random number table, and carrying out initial setup of the random number table.

9. A pseudo-random number generator as defined in claim 7, wherein:
the means for outputting selectively used random number table are plurally provided in said part for outputting a selectively used random number bit string,
the random number table is provided to correspond to each of the means for outputting selectively used random number table in said part for outputting an amplified random number bit string,
the means for generating the amplified random number bit string selects a corresponding amplified random number bit string from the random number table by referring to the random number table corresponding to each of the means for outputting selectively used random number bit string respectively using the selectively used random number bit strings outputted from each of the means for outputting selectively used random number bit string, and
the means for nonlinearly converting outputs pseudo-random numbers by nonlinearly converting the amplified random number bit string selected from each of the random number tables by nonlinear function using each of the means for generating the amplified random bit string in said part for nonlinearly converting the amplified random number bit string.

10. A pseudo-random number generator as defined in claim 9, wherein plural random number tables are provided corresponding to each of the means for outputting selectively used random number bit string in said part for outputting an amplified random number bit string, and
which is further provided with means for subjecting each of the amplified random number bit strings selected from each of the random number tables by the means for selecting the amplified random number bit string to exclusive-or operation every the means for outputting a selectively used random number bit string of the part for outputting a selectively used random number bit string and outputting to the nonlinear conversion means.

11. A pseudo-random number generator as defined in claim 9, wherein said part for outputting an amplified random number bit string is further provided with means for replacing the random number tables with each other at a predetermined time.

12. A pseudo-random number generator as defined in claim 11, wherein the means for replacing the random number tables in said part for outputting a selectively used random number bit string has function of replacing the random number tables with each other every time that the means for outputting a selectively used random number bit string outputs the selectively used random number bit string required for referring to each of the random number tables.

13. A pseudo-random number generator as defined in claim 11, wherein the means for replacing the random number tables has function of generating random number for replacing random number tables having the same number as that of each of the random numbers, giving the random numbers for replacing random number tables to each of the random number tables as a table number of random number table, and replacing order of the random number tables according to a rule predetermined based on the table number.

14. A program to be executed by a computer for generating pseudo-random numbers comprising:
a part for outputting a selectively used random number bit string having a predetermined bit number based on a secret key;
a part for outputting an amplified random number bit string having bits of a larger bit number than the selectively used random number bit string based on the selectively used random number bit string outputted from the part for outputting a selectively used random number bit string; and
a part for nonlinearly converting the amplified random number bit string outputted from the part for outputting an amplified random number bit string to output pseudo-random numbers;
said part for outputting a selectively used random number bit string comprising:
a linear feedback shift register having n shift resistors and capable of outputting a bit string having bit number of (2ˆn)-1 per one cycle.
means for setting up an initial state value of the linear feedback shift register based on a secret key,
means for determining a derived value prime to the bit number per one cycle of the linear feedback shift register based on the initial state value by means of a predetermined operation processing,
means for multiplying the derived value by a value obtained by multiplying the bit number corresponding to one cycle by two or more to calculate a bit numbers to be outputted from the linear feedback shift register,
means for outputting a bit string corresponding to the bit number calculated by the above means based on the initial state value from the linear feedback shift register,
means for taking out a bit from the output bit string outputted from the above means every the number of the derived value to generate a new bit string,
means reconstructing of the linear feedback shift register such that the new bit string can be outputted from the resistor, and
means for outputting selectively used pseudo-random numbers based on the initial state value using the reconstructed linear feedback shift register reconstructed by the above means,
said part for outputting an amplified random number bit string comprising:
a random number table in which a plurality of amplified random bit strings having larger bit number than that of the selectively used random number bit string is stored, and
means capable of selecting a corresponding amplified random number bit string from the plurality of amplified random number bit strings within the random number table by referring to the random number table using the selectively used random number bit string outputted from the means for outputting selectively used random number bit string; and
said part for nonlinearly conversing the amplified random number bit string comprising means for nonlinearly conversing the amplified random number bit string selected by the means for selecting the amplified random number bit string by a nonlinear function to output pseudo-random numbers.

15. A program to be executed by a computer as defined in claim 14, further comprising means for generating the amplified random number bit string by a given secret key, storing the bit string in a random number table, and carrying out initial setup of the random number table, in the part for outputting an amplified random number bit string.

16. A program to be executed by a computer as defined in claim 15, wherein:
the means for outputting selectively used random number table are plurally provided in said part for outputting a selectively used random number bit string,
the random number table is provided to correspond to each of the means for outputting selectively used random number table in said part for outputting an amplified random number bit string,
the means for generating the amplified random number bit string selects a corresponding amplified random number bit string from each of the random number tables by referring to the random number table corresponding to every each of the means for outputting selectively used random number bit string using the selectively used random number table outputted from each of the means for outputting selectively used random number bit string, and
the means for nonlinearly converting outputs pseudo-random numbers by nonlinearly converting the amplified random number bit string selected from each of the random number tables using each of the means for generating the amplified random number bit strings in said part for nonlinearly converting the amplified random number bit string.

17. A program to be executed by a computer as defined in claim 16, wherein plural random number tables are provided every each of the means for outputting selectively used random number bit string in said part for outputting an amplified random number bit string and
which is further provided with means for subjecting each of the amplified random number bit strings selected from each of the random number tables by the means for selecting the amplified random bit string to exclusive-or operation every the means for outputting selectively used random number bit string of said part for outputting a selectively used random number bit string and and outputting to the means for nonlinearly conversing of said part for nonlinearly conversing the amplified random number bit string.

18. A program to be executed by a computer as defined in claim 17, which is further provided with means for replacing the random number tables with each other at a predetermined time in said part for outputting an amplified random number bit string.

19. A program to be executed by a computer as defined in claim 18, wherein the means for replacing the random number tables has function of replacing the random number tables with each other every time that the means for outputting the selectively used random number bit strings of the part for outputting a selectively used random number bit string outputs the selectively used random number bit string required for referring to each of the random number tables.

20. A program to be executed by a computer as defined in claim 18, wherein the means for replacing the random number tables has function of generating random numbers for replacing random number tables having the same number as that of each of the random numbers, giving the random numbers for replacing random number tables to each of the random number tables as a table number of random number table, and replacing order of the random number tables according to a rule predetermined based on the table number.
